(19) United States
(12) Patent Application Publication
(10) Pub. No.: US 2024/0302791 A1
(43) Pub. Date: Sep. 12, 2024

(54) METHOD AND SYSTEM OF SPATIAL LIGHT MODULATOR CALIBRATION

(71) Applicant: Intel Corporation, Santa Clara, CA (US)

(72) Inventors: Alexey Supikov, Santa Clara, CA (US); Michael Mefenza Nentedem, Santa Clara, CA (US)

(73) Assignee: Intel Corporation, Santa Clara, CA (US)

(21) Appl. No.: 18/118,642

(22) Filed: Mar. 7, 2023

(51) Int. Cl. G03H 1/02; G03H 1/08

(52) U.S. Cl. CPC G03H 1/02; G03H 1/0808; G03H 2001/0224; G03H 2225/32

(57) ABSTRACT

A method and system calibrates spatial light modulators.

### BACKGROUND

Holographic display devices used for computer generated holography (CGH) may present holographic images in a variety of applications including automotive heads up displays (HUDs), surface-adaptive home projectors, dynamic digital signage, augmented reality (AR) displays, virtual reality (VR) displays, 3D optical printing, optical computing, and others. Such holographic display devices have advantages over other displays including an inherent ability to focus light at different distances, very high light efficiency with relatively unlimited brightness, digitally simulated dynamically focused optics, and small size, to name a few examples. The holographic display devices typically have a spatial light modulator (SLM) that has many small pixels that are capable of modulating phase of light or amplitude (or light intensity). The conventional holographic display devices convert a target image into a holographic diffraction pattern image (or encoded phase map or just phase map) with particular phase levels for individual pixels. In order to control phase delay of individual pixels of an image at the SLM, the SLM can change the direction of electrically controlled liquid crystal (LC) molecules at the pixels according to the diffraction pattern image data. This in turn can individually change the phase of light being reflected at the individual pixels at the SLM when a coherent light source is aimed at the SLM. Such conventional holographic devices and SLMs, however, still have inadequate configurations, manufacturing processes, and calibration processes that result in relatively lower quality images compared to theoretically attainable images.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of an example holography display arrangement according to at least one implementation disclosed herein;

FIG. 2 is a schematic diagram of an alternative holographic imaging arrangement that may be used in a holography display system such as that of FIG. 1 and according to at least one implementation disclosed herein;

FIG. 3 is a schematic diagram of an example transmissive holography display arrangement according to at least one implementation disclosed herein;

FIG. 4 is a schematic diagram of an example spatial light modulator (SLM) projection setup with a far-field diffraction pattern produced by an example SLM according to at least one implementation disclosed herein;

FIG. 5 is an apodised sine-wave graph of a horizontal cross-section of an interference pattern order resulting from projection of a phase map with a slit pair according to at least one of the implementations disclosed herein;

FIG. 6 is a schematic diagram showing a phase map with a phase shift-measuring double-slit grating pattern and a reference double-slit grating pattern according to at least one of the implementations disclosed herein;

FIG. 7A is a schematic diagram of a close-up of a phase shift-measuring double-slit grating pattern with a grating period according to at least one of the implementations disclosed herein;

FIG. 7B is a schematic diagram of a close-up of a reference double-slit grating pattern with a grating period according to at least one of the implementations disclosed herein;

FIG. 8 is a graph of an example phase response transfer curve according to at least one of the implementations disclosed herein;

FIG. 9 is an annotated image of an interference pattern resulting from projection of a phase map with two double-slit grating patterns according to at least one of the implementations disclosed herein;

FIG. 10 is a schematic diagram of a phase level sequence on a grating with another example grating period according to at least one of the implementations disclosed herein;

FIG. 11A is an apodised sine-wave graph of an interference pattern resulting from projection of a phase map with a measuring double-slit grating pattern according to at least one of the implementations disclosed herein;

FIG. 11B is an apodised sine-wave graph of an interference pattern resulting from projection of a phase map with a reference double-slit grating pattern according to at least one of the implementations disclosed herein;

FIG. 12 is a schematic diagram of an example system according to at least one of the implementations disclosed herein;

FIG. 13 is a flow chart of an example process of holographic imaging with vibration compensation according to at least one implementation disclosed herein;

FIGS. 14A-14C is another flow chart of another example process of holographic imaging with vibration compensation according to at least one implementation disclosed herein;

FIG. 15 is a graph of a target phase response transfer curve;

FIG. 16 is a graph of an actual phase response transfer curve with non-compensated vibration;

FIG. 17 is a graph of a vibration phase response transfer curve;

FIG. 18 is a graph of a phase response transfer curve with vibration compensation according to at least one implementation disclosed herein;

FIG. 19A is a schematic diagram of a close-up side-cross-sectional view of an SLM according to at least one implementation disclosed herein;

FIG. 19B is a schematic diagram of an SLM pixel array surface superimposed with a phase map having a double-slit grating pattern at an orientation and a projected interference pattern according to at least one implementation disclosed herein;

FIG. 19C is a schematic diagram of an SLM pixel array surface superimposed with a phase map having a double-slit grating pattern at another orientation and a projected interference pattern according to at least one implementation disclosed herein;

FIG. 20 is a graph showing phase response transfer curves varying due to diffraction angle according to at least one implementation disclosed herein;

FIG. 21 is a flow chart of an example process of holographic image processing with diffraction angle-dependent phase response transfer curve generation in accordance with at least one of the implementations herein;

FIGS. 22A-22B is another flow chart of another example process of holographic image processing with diffraction angle-dependent phase response transfer curve generation in accordance with at least one of the implementations herein;

FIG. 23 is an illustrative diagram of another example system; and

FIG. 24 is a schematic diagram an example device, all arranged in accordance with at least some implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or commercial or consumer electronic (CE) devices such as computer, a laptop computer, a tablet, set top boxes, game boxes, smart phones, virtual reality headsets, etc., may implement the techniques, systems, components, and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof unless stated otherwise. The material disclosed herein also may be implemented as instructions stored on a machine-readable medium, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth. References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein. Also, as used in the description and the appended claims, the singular forms “a”, “an” and “the” are intended to include the plural forms as well, unless the context clearly indicates otherwise. It also will be understood that the term “and/or” as used herein refers to and encompasses any and all possible combinations of one or more of the associated listed items.

Methods, systems, devices, apparatuses, computing platforms, and articles are described herein related to spatial light modulator calibration.

In various contexts, a holographic imaging arrangement or system (or projector) may be employed to display holographic images to a user. The holographic imaging arrangement may include a light source, a spatial light modulator (SLM), various optical elements, and the spatial arrangement of such components. As used herein, the term holographic imaging arrangement indicates an arrangement of any components for the display of a holographic image to a user. The term holographic image indicates any hologram that is displayed to a user including 2D or planar holograms, 3D holograms, or holograms projected onto a screen. Notably, such holographic images can be seen with the naked eye and are generated using interference patterns generated by diffraction of light. Furthermore, a target holographic image is provided for eventual display to the user using the holographic imaging arrangement. The target holographic image, as the name suggests, is the image that is to be shown to the user via the holographic imaging arrangement.

In the context of phase modulation SLMs, a holographic system may have a particular target holographic image to be displayed. The target holographic image data is used to generate a corresponding holographic diffraction pattern (or image or phase map) that is provided to, and in turn displayed on, the SLM to propagate light to form the target holographic image. Specifically in image generation, holographic projectors and displays use principles of diffraction and interference to form a desired image that is a distribution of spots of different amplitudes and at desired distances.

The nature of an image produced or output by a spatial light modulator (SLM) is a function of the wavefront of the light beam input to the SLM and how individual pixels of the SLM are controlled to modulate or adjust the light beam. Inasmuch as SLMs are fully programmable, it is theoretically possible for an SLM to produce any desired output image from the same input light beam. However, high quality images (e.g., images with little to no noise and/or graininess, images with relatively high sharpness, images with relatively high contrast, images with relatively high resolution, etc.) depend upon a correct understanding of the wavefront of the input light beam and correctly controlling the individual pixels of the SLM modulating or adjusting the input light beam.

In more detail, individual pixels of an SLM are controlled to adjust or modulate the input light received at each pixel by a particular amount. In phase-only SLMs, applying different voltages to different pixels causes the corresponding pixels to modulate the phase (or time delay) of the light to a different extent. The voltages for all pixels in the SLM are defined by different pixel values (e.g., for example ranging from 0 to 255 when a greyscale image is used as a phase map). Thus, for example, a minimum voltage (e.g., no voltage defined by a pixel value of 0) applied to a particular pixel causes a phase shift of 0 in the output light beam (e.g., no delay). By contrast, a maximum voltage (e.g., defined by a pixel value of 255) applied to a particular pixel causes a phase shift of 2× or more (e.g., a delay of one full wavelength of light). Ideally, each voltage corresponding to each pixel value between the minimum and maximum produces an incremental change in the resulting amount of phase shift. However, in reality, the relationship to voltage level and phase shift is not linear. Furthermore, the non-linear relationship of the voltage-to-phase response for pixels in an SLM is not necessarily consistent across all pixels in the SLM but can differ depending on the X-Y location of the pixels within the SLM pixel surface. Also, non-ideal collimated input light can cause variations in phase of the light output from the liquid crystals at the SLM pixels. Otherwise, differences in the voltage-to-phase response of particular pixels can arise from the phase retardation and attenuation response of a liquid crystal SLM or the variable physical displacement of a microelectromechanical (MEMs) element. Further still, in some examples, the voltage-to-phase response transfer function depends upon the particular wavelength of light being modulated. Unless the differences in the voltage-to-phase response of the pixels of an SLM are accounted for, the actual output of an SLM will be degraded relative to an intended output (e.g., image quality will be reduced).

The disclosed method and system measure the unintentional variations in the phase response by using a double-slit grating pattern on the greyscale image that is input to the SLM to project a diffraction interference pattern onto a far-field screen. The projected holographic image is then captured by a camera. The phase for individual pixels then can be measured by analyzing the image data of the interference pattern on the captured image. The double slit-grating pattern can be moved around the SLM pixel surface from greyscale image to greyscale image to capture accurate local image data on all areas of the SLM pixel surface and stored as a phase response transfer curve. With this configuration, the double-slit technique achieves more accurate measurement of the voltage-to-phase response of the pixels across an SLM so that pixel values (e.g., in a phase map or greyscale image) defining voltage values result in a more expected phase shift, thereby enabling better control of the output wavefront to produce high quality images. Note that the voltage-to-phrase response (or phase response transfer curve or function) herein may simply be referred to as the “phase response”.

In addition, the disclosed method and system also use the double-slit grating patterns to compensate for vibration. Specifically, such a far-field measurement system should have sufficiently sturdy or secure mechanical mounting of a large screen, camera, SLM, and light source with the screen placed at a relatively large distance from the SLM and camera. Without such very secure structures, this makes the system susceptible to undesirable variations in phase that lower output image quality with even relatively small vibrations.

Thus, the disclosed methods and systems determine accurate phase responses based on a direct measurement of the output of an SLM without the need for complex computations or specific underlying models and while detecting and compensating for phase measurement errors caused by vibration. Furthermore, the vibration compensation examples disclosed herein can be performed in-situ without any significant amount of space or extra components or fixtures to determine accurate phase response transfer curves beyond that used for typical calibration.

This is accomplished by isolating and determining a vibration phase shift at a vibration or reference double-slit grating pattern (or just reference grating pattern or reference slit pair) on a phase map input to the SLM and caused by vibration of the components in the holographic system rather than any intentional phase shift. The vibration phase shift is then subtracted from intentional phase shifts at measurement (or measuring) double-slit grating patterns (or just measuring grating patterns or simply measuring slit pairs) to obtain vibration-compensated phase shifts that can be used to determine very accurate vibration compensated phase responses. Thus, imperfections in the SLM system (e.g., inaccuracies in the expected phase responses of the SLM itself) can be compensated for, thereby reducing or even effectively eliminating the imperfections from vibration.

In more detail, and according to Young's double-slit interference experiment, far-field diffraction of light coming through two narrow and long openings (or slits) creates an apodised sine pattern, laterally shifted according to a phase difference between two light beams leaving the openings. The slits can be simulated on an SLM by controlling the pixel phases on the SLM to create virtual gratings inside each slit that create an interference pattern with light diffraction that moves away from a zero-order spot of the interference pattern. Notably, when a grating period inside the slit changes, the pattern moves according to the diffraction angle set by the dimensions and parameters of the grating.

Thus, for the vibration-compensating double-slit grating pattern method and system herein, a reference slit pair on the phase map provides an additional pair of narrow gratings on the same phase map as a measuring slit pair but with a different grating period than that of the measuring slit pair to create an additional apodised sine pattern used as a reference to detect and compensate for vibrations. By changing the grating period from the measurement grating pattern to the reference grating pattern, the measurement phase response may be detected from one interference pattern, while the reference or vibration phase response may be detected from another interference pattern that is spaced from the measuring interference pattern on a holographic image on a projection screen. This method and system results in the compensation of both small and relatively large vibration, thereby relaxing the mechanical setup strength or sturdiness requirements that can be relatively difficult, time consuming, and/or costly to satisfy, and while increasing the phase response accuracy, and in turn image quality, of the output holographic images.

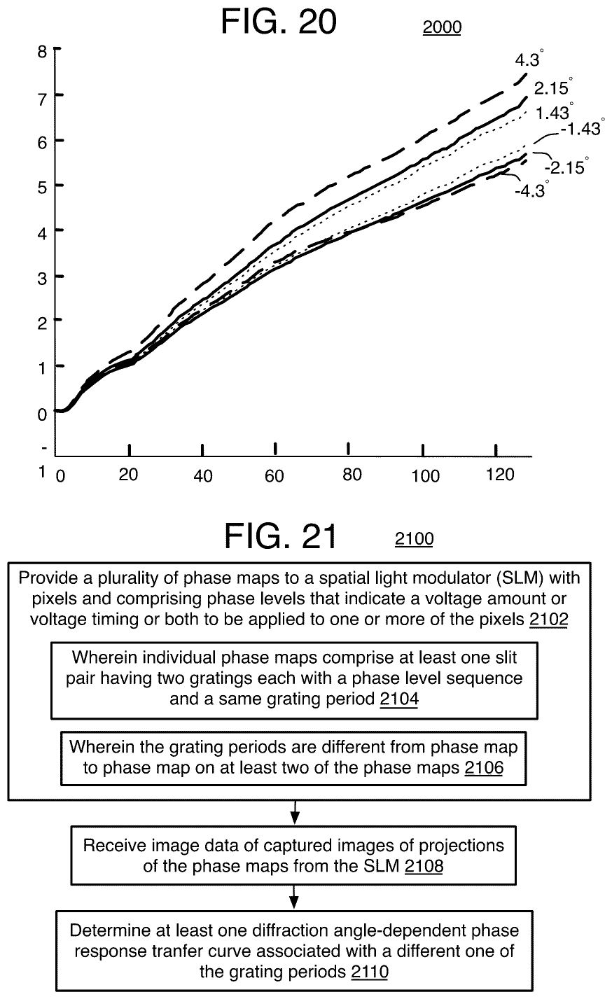

As an optional additional feature, a self-reference method and system of angle-dependent phase modulation response may be used to enable characterization of devices (especially liquid crystal SLMs) with large FOV applications, such as projectors. Specifically, it also has been determined that the pixel-level phase response at the SLM changes depending on the diffraction angle of incident light input to the liquid crystals of the SLM pixels (See FIG. 20 discussed below). Thus, when the desired diffraction angle of the incident light can be determined, phase responses associated with a specific diffraction angle can be used, thereby further increasing the accuracy of the phase response, and in turn the quality of the output image. This is accomplished by varying grating periods of the double-slit grating patterns or slit pairs on phase maps to be input to the SLM to determine the phase response at various diffraction angles relative to a propagation direction and in the same general rotational direction from a single pixel. The slit pairs also then may be rotated by 90 degrees on the phase maps to determine phase responses for diffraction angles extending in different rotational directions. Since most of the liquid crystal SLMs are using a parallel alignment ECB regime, the angle-dependent modulation effect is strongest along an alignment (rubbing) direction and is practically negligible in the orthogonal direction. Alignment orientation typically coincides with an X or Y direction on the SLM, so performing measurements using a slit pair oriented vertically (along the Y axis) and then oriented horizontally (along the X axis) allows for capturing of major angle-dependent effects along the rubbing direction and confirms very small angle variations in the direction orthogonal to the rubbing direction.

The angle-dependent phase response detection method and system may be (1) used alone, (2) used with the slit pair phase response measurement technique, (3) used with the vibration compensation technique, or (4) all three may be used together. The angle-dependent phase response method and system also preserves simplicity, affordability, and locality of the phase response measurement technique.

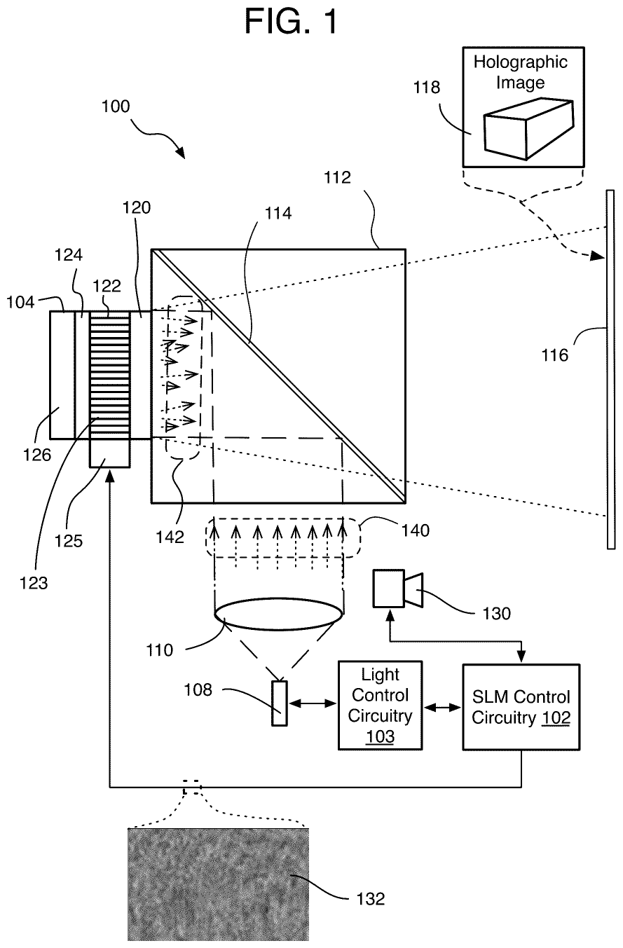

Referring now to FIG. 1, a number of different holographic or SLM arrangements can be used to measure phase response for phase response calibration. The holographic setup or arrangements may be any that project far field (Fraunhofer or free space Fresnel mode) images from the SLM to a diffusive projection screen. The arrangements that can be used include devices with reflective or non-reflective (or transmissive) types of SLMs. Here, an example on-axis reflecting vibration-compensated holographic imaging system or arrangement 100 (also referred to as a holographic device or projector) is arranged in accordance with at least some implementations of the present disclosure. The holographic imaging arrangement 100 may be implemented at least partially in any suitable form factor device such as a motor vehicle platform, a virtual reality (VR) headset platform, an augmented reality (AR) headset platform, multi-focal head mounted displays (HMDs), a personal computer, a laptop computer, a tablet, a phablet, a smart phone, a digital camera, a gaming console, a wearable device, a display device, an all-in-one device, a two-in-one device, and so forth.

The holographic imaging arrangement 100 may include SLM control circuitry (or just SLM control or controller) 102 that controls an SLM 104. A light source 108 projects coherent light through collimator optics (or a collimator) 110 to form an ideally uniform plane wavefront 140 (e.g., coherent, collimated, and with a uniform intensity). The optics 110 optionally may have other optics not shown, such as a polarizer. The collimated light then propagates to a beam splitter 112. The beam splitter 112 reflects the light into the SLM 104 as shown by the long dashed lines. The SLM 104 then reflects the light back through a phase-controlled liquid crystal layer 122 (with exaggerated shape here for emphasis) on the SLM 104 to form an output wavefront 142 that propagates back through the beam splitter 112, and to an image plane 116 such as a display or screen 116 to form a holographic image 118 that can be captured by a camera during calibration and that is visible to a user during a runtime. By one form, the SLM 104 may be a liquid crystal on silicon (LCoS) SLM.

The SLM control 102 may generate diffraction pattern image data using computer generated hologram (CGH) algorithms for displaying a corresponding hologram (or holographic image 118), and/or the SLM control circuitry 102 may transmit the diffraction pattern image data to another device with an SLM for display of the hologram. The holographic system 100 may have the SLM control 102 integrated into the same housing, motherboard, system on a chip platform, and so forth, as the other projector and display components. As used herein, the term integrated system indicates a system integrated into at least the same device package or housing.

The light source 108, such as at least one laser light source, light emitting diode (LED), a superluminescent light emitting diode (SLED), and so forth may emit coherent or partially coherent light with an ideally constant phase or uniform phase profile as well as a constant amplitude, or may have reasonably curved (e.g. Gaussian) waveform and known non-uniform intensity profile. There may be one laser for each desired wavelength when the lasers have very small bands.

As shown in the illustrated example, the light source 108 may be controlled by light control circuitry 103. In some examples, both the light control circuitry 103 and the SLM control circuitry 102 are implemented by a single control circuit. In some examples, each of the light source 108, the optical elements 110, the SLM 104, the light control circuitry 103, and the SLM control circuitry 102 of the SLM system 100 are incorporated into a single electronic device. In other examples, different ones of the components of the SLM system 100 may be associated with and/or implemented in different devices. For instance, in some examples, the light source 108, the optical elements 110, and the SLM 104 are implemented in a first electronic device and the SLM control circuitry 102 is implemented in a separate standalone device (e.g., a standalone computer or smartphone).

The beam splitter 112 may have a diagonal splitting or reflection layer 114 and is formed of triangular glass prisms, half-silvered mirrors, coatings, and/or other known optical beam splitting structures.

Although illustrated with respect to SLM 104, any suitable holographic imaging device may be employed that displays a diffraction pattern image, and in this case, a double slit interference pattern. By one example form, the SLM 104 may have a glass layer 120 that covers the liquid crystal film (or liquid crystal (LC) layer) 122 with liquid crystal pixels, which in turn is above a mirror or mirror layer 124. These layers may be supported by a substrate 126. A pixel control circuit 125 may receive driving signals (encoded by n-bit numbers from a phase map 132) and converts the signals into an electrical field with voltages or electrical pulses or certain voltage timing to control the phase at the individual pixels on the SLM. The SLM 104, based on driving signals from the SLM control 102 and representing the phase map 132 (or a diffraction pattern image data map), generates a corresponding diffraction pattern image within a surface layer of the SLM 104 such as at the liquid crystal layer 122. For explanatory purposes, the transmission of the driving signals may be generalized to state that the SLM control 102 provides a phase map (or diffraction pattern image) 132 to the SLM 104.

The SLM's LC layer 122 may be pixelated (alterable at a pixel level) to provide a modulated image surface representative of diffraction pattern image data. The SLM 104, or more precisely the LC layer 122, may include any number of pixels 123 and have any size. For example, the SLM 104 may have 3, 4, or 6 micron pixels 123 in LC layer 122 with any desired resolution, such as 1920×1080, and the LC layer 122 may be about 12×12 mm to 15×15 mm in surface area, although any pixel size and surface layer 122 area size may be employed.

Furthermore, the LC layer 122 modulates phase of the incident coherent light from the light source to generate the holographic image 118. Specifically, the diffraction pattern image data including phase data may be provided to the SLM 104 in order to control the orientation (rotation) of crystal molecules on the LC layer 122, thereby changing the phase of the light emitted by individual pixels of the SLM 104.

As used herein, the term diffraction pattern image or phase map indicates an image displayed on an SLM or other holographic display device while the terms diffraction pattern image data and phase level indicate the data, in various formats, used to generate the diffraction pattern image. By one example form, this may be greyscale values. At a particular distance from the SLM (which may include optics between the SLM and the viewing space), the resultant wavefront generates the holographic image 118. The projected holographic image 118 during a runtime may be planar or it may have depth to provide a 3D hologram. As used herein, the term holographic image indicates a planar or 3D holographic image or hologram. For example, the resultant light field from the SLM may focus to an individual plane or to multiple adjacent planes during a run-time to generate 3D imagery. Furthermore, time multiplexing techniques may be used to generate the effect of 3D imagery by refreshing planar or 3D holographic images at a rate faster than what is noticeable to the human eye.

Holographic image 118 may be based on, and may include images of, one or more interference patterns provided by modulated light that is observed or detected at a particular distance from the SLM 104. In the context of phase modulation, no amplitude modulation occurs such that any amplitude variation within holographic image 118 is generated based on constructive and destructive interference as provided by the diffraction pattern image data to the SLM 104. Although illustrated with respect to a planar holographic image 118, holographic imaging arrangement 100 and the techniques discussed herein may be employed to generate 3D holographic images.

Image plane or screen 116 may be a standard diffusive screen surface reflective to all or most wavelengths of light, or screen 116 may be reflective only to a band of light corresponding to the band of light of the incident coherent light and modulated light while being translucent with respect to other bands of light and, in particular, to other bands of visible light. For example, screen 116 may be glass (e.g., a windshield of a car) that has elements that are (largely) invisible to the naked eye but reflect a narrow band of wavelengths around those of coherent light and modulated light. In some implementations, screen 116 includes optical elements that further project and/or reflect modulated light such that, for example, holographic image 118 appears to be over the hood of an automobile.

The holographic arrangement 100 also has image sensors 130, which may be a camera. The SLM control circuitry 102 is in communication with the camera 130. In this example, the camera 130 is constructed and oriented to capture the output of the SLM 104. For instance, the camera 130 captures the light, and in this calibrating case interference patterns, projected from the SLM 102 and onto the surface 116. Additionally or alternatively, in some examples, the camera 130 may be positioned to directly capture the output light emanating from the SLM 104. The camera 130 may be incorporated into the same electronic device as the rest of the holographic arrangement 100, and/or the SLM control circuitry 102. In other examples, the camera 130 may be a standalone device that is separate from the SLM control circuitry 102 (which may or may not be incorporated into the same device as the rest of the SLM system 100).

Furthermore, diffraction pattern image data may be transmitted from SLM control 102 to SLM 104 or another component of a holographic display using any suitable technique or techniques. In some implementations, SLM control 102 is local to SLM 104 such that they are implemented in the same device. In other implementations, SLM control 102 is remote from SLM 104 and diffraction pattern image data is transmitted to SLM 104 via wired or wireless communication. In some implementations, the phase maps may be stored in a memory accessible to SLM 104.

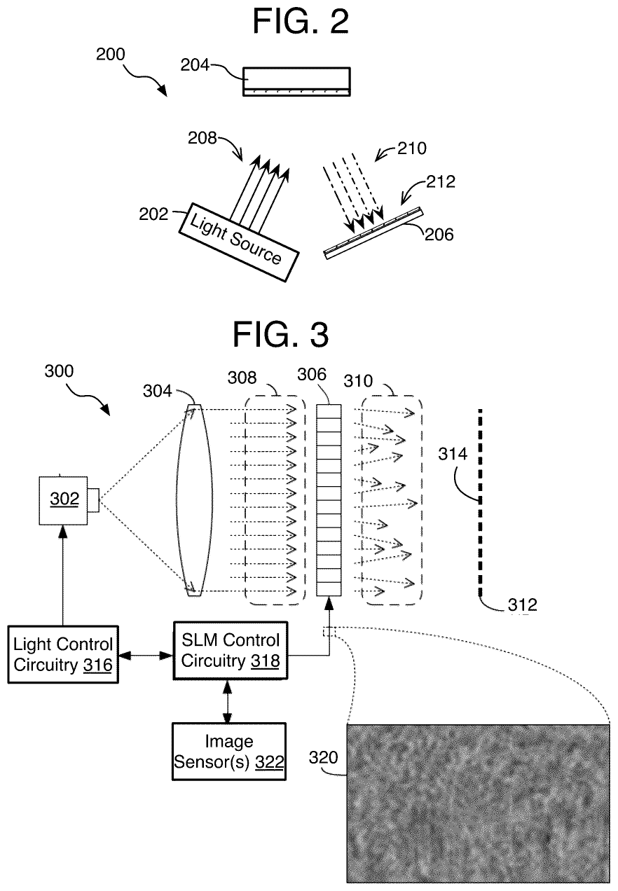

Referring to FIG. 2, an alternative off-axis holographic imaging arrangement 200 (also referred to as a holographic system, device, or projector) is shown and is similar to arrangement 100 except without a beam splitter. Instead, arrangement 200 has a light source 202 emitting light 208 directly toward an SLM 204. The SLM 204 is arranged to reflect the light 210 through a phase-modifying liquid crystal layer and toward the display 206 to form a holographic image 212. Otherwise, the operation of the arrangement or system 200 is the same or similar to the system 100. The light source 202 may include a laser LED and collimation optics.

Referring to FIG. 3, yet another holographic arrangement 300 with a transmissive SLM 306 can be used instead of a reflective arrangement. The arrangement 300 has the light source 302, collimator and other optics 304, transmissive SLM 306 and screen 312. SLM control circuitry 318 provides a phase map 320 to the SLM 306 while controlling light control circuitry 316 to emit ideally collimated light 308 from light source 302. The light from light source 302 and collimator 304 propagate through the SLM 306, and its liquid crystal pixels, to emit modulated, diffracted light 310 that forms a holographic image 314 with a diffraction interference pattern on the screen 312. The SLM 306 does not have a reflector in this case. Otherwise, the operation as described with holographic arrangement 100 applies here as well.

Referring again to FIG. 1 in more detail, the output wavefront 142 is different than the input wavefront 140 because the light is modified by the SLM 104. More particularly, in this example, the SLM pixels 123 forming the liquid crystal layer 122 cause the incident light to scatter or diffuse. The angle of the arrows in the output wavefront 142 are not intended to indicate a particular direction for the beam of light but to represent that the light is no longer collimated. Further, in this example, the SLM 104 modifies the light by modulating the phase of the light such that it is no longer coherent. More particularly, the pixels of the SLM 104 modulate the phase of a corresponding portion of the light in accordance with a voltage applied to the pixel 123. Changing or modulating the phase effectively delays the corresponding portion of the light relative to other portions of the light. In some examples, each pixel can shift the phase of the portion of light it affects up to 2×, thereby causing the light associated with the corresponding pixel to be delayed by up to a full wavelength of the light. The phase delay or phase shift is represented by the different lengths of the arrows and the locations of the arrowheads in the output wavefront 142 of FIG. 1. In this example, the SLM 104 is a phase-only SLM such that the intensity of the output wavefront 142 is generally consistent with the input wavefront 140. In other examples, the SLM 104 may also modulate the intensity of the light.

The SLM 104 can control the phase delay of the light associated with each pixel 123 in the SLM 104 so that the SLM 104 can produce a particular interference pattern of the light at the specified image plane 116 as the wavefront 142 propagates outward. In this example, the particular interference pattern corresponds to the holographic output image 118. The SLM 104 can produce different images by adjusting the voltages applied to the pixels, or by controlling timing of the voltage, such as by pulses, to correspondingly adjust the phase delays of the light so as to produce a different interference pattern corresponding to the intended output image.

Each pixel in the SLM 104 can be set to achieve any one of a set of available phase delay values: Φ₀, Φ₁, . . . , Φᵢ, . . . , Φ_{N-1}, where N is the maximum number of phase levels supported by an SLM (e.g., 256). The index i of Φᵢ (here 0 to 255) is called phase level (or sometimes voltage level unless the context suggests otherwise to be actual voltage (volt) values). As mentioned, a target hologram is typically provided to the SLM 104 from the SLM circuitry 102, directly or via other circuitry, as a 2D phase map (2D array) of per-pixel phase levels (similar to image colors). Such 2D phase maps can be encoded in larger encoding structures with multiple holograms, such as a typical image bitmap and by using RGB components and/or some bit allocation (mapping) scheme. Here, greyscale mapping of phase levels 0 to 255 is one example.

The SLM control circuitry 102 controls the SLM 104 to cause particular voltages to be applied to corresponding pixels in the SLM 104. In some examples, the particular voltages for the pixels are defined by corresponding pixel levels in the phase map 132. Specifically, when the phase map is a greyscale image, a pixel level of 0 corresponds to a black pixel in the greyscale image 132 and is intended to cause no phase delay (e.g., a phase shift of 0). Further, a pixel value of 255 corresponds to a white pixel in the greyscale image 132 and is intended to cause a maximum phase delay (e.g., a phase shift of 2×). As can be seen, there is no apparent visual correlation between the greyscale image 132 that defines the voltages applied to the pixels and the resulting output image 118 produced at the image plane 116. This occurs because the greyscale image 132 merely defines the phase delays of light from individual ones of the pixels and such phase delays, in turn, produce the interference patterns corresponding to the output image 118.

Alternatively, the phase map can be generated by other color schemes or image data structures than greyscale. For example, each pixel in the hologram is often encoded as a 1, 2, 4, 8, or larger bit value, and this phase level may correspond to some expected phase amount, and in turn to a voltage value or pulse timing. By one form, the phase levels are 8-bit RGB values with 24 bits per pixel. Different schemes that can be used to form phase levels include W×H size RGB bitmaps that encode three holograms: one with all R values, another with all G values, and a third with all B values. This hologram may be displayed one after another as a sequence. Otherwise, the phase map may have 2W×2H pixels where each bit is an RGB triplet (24 bits total) and encodes one bit of a phase map, so that the phase map encodes 24 4-bit maps (each 4 bits correspond to 16-phase levels). Other color schemes can be used as well.

In some examples, as described in further detail below, the SLM control circuitry 102 uses feedback from the image sensor 130 to determine the vibration-compensated phase response of the pixels of the SLM receiving the input light wavefront 140 incident on the SLM 104. More particularly, in some examples, the SLM control circuitry 102 determines phase response curves for different locations on the pixel array or layer 122 of the SLM 104 that define the resulting phase shift for various applied voltages at the corresponding locations of the pixels of the SLM 104. In some examples, the SLM control circuitry 102 stores these phase response curves in memory (e.g., as values in a lookup table(s)) so that the holographic device can generate the proper voltage to produce a proper phase shift that gives rise to an intended interference pattern corresponding to the output image.

To accomplish this, examples disclosed herein involve a specific far field application of Thomas Young's double-slit experiment. Briefly, the double-slit experiment involves shining a coherent beam of light through two parallel slits in an otherwise opaque plate. The slits cause the light to diffract as it propagates passed the plate towards a screen. The diffracted light from the two slits interfere with each other to produce an interference pattern of alternating bright (e.g., high intensity) and dark (e.g., low intensity) bands (or interference pattern orders) on the screen. The intensity (I) of light of the interference pattern can be expressed mathematically by one form of the Fraunhofer diffraction equation as follows:

$$I ( θ ) ∝ {cos}^{2} [ \frac{π d sin θ}{λ} ] sin {c}^{2} [ \frac{π b sin θ}{λ} ] \qquad ( 1 )$$

where θ is the angle from a direction normal to the plane containing the slits at a midpoint between slits, d is the spacing between slits, b is slit width, λ is light wavelength, sin θ is the normalized lateral shift along the interference pattern, of the two slits that is a sine wave with a frequency proportional to spacing between slits and with a width inversely proportional to a slit width and sinc2[ ] is the apodised version of the interference pattern. Significantly, the phase of the interference pattern defined by eq. (1) relates directly to the difference in phase of light transmitted through the two slits, or in other words, the phase shift of the sine wave in the pattern is exactly half of the mean phase difference between phases of light leaving the slits. Thus, for example, if the first slit included a piece of glass that introduces a π phase shift (relative to the second slit), the interference sine pattern produced by the diffracted light would theoretically be shifted by exactly π (relative to an interference pattern produced by both slits transmitting light that is perfectly in phase). Thus, measuring the phase shift in an interference pattern produced by two slits corresponds to a direct measurement of the phase difference in light transmitted by the two slits.

Thus, the phase difference between the slits can be directly measured by measuring the phase shift of an interference pattern produced by the slits. This relationship can be used to measure the resulting phase at the SLM pixels to generate actual phase responses by controlling individual pixels in the SLM in a manner that mimics the double-slit experiment described above. Notably, SLMs do not have actual slits. However, particular voltages applied to particular ones of the pixels can recreate the effect of the double-slit experiment. For SLMs that modulate the intensity of a beam of light, the double-slit experiment can be recreated by setting the voltage applied to pixels corresponding to the slits to produce a high intensity output and setting the voltage applied to the other pixels (not corresponding to the slits) to produce a low intensity of light.

For phase-only SLMs, however, recreating the double-slit experiment is not so straightforward because such SLMs are only capable of modulating the phase of the light. However, a double-slit experiment can be mimicked using a phase-only SLM by setting the voltage applied to the pixels corresponding to some value different from the constant value of all other pixels (background value). Slits with a constant value will create an interference pattern aligned to the center of a reflected beam. It will be impossible to separate the bright spot created by reflection from background pixels (where background pixels having all the same phase delay values will act like a mirror). However, it still is possible to direct an interference pattern away from the center by setting the voltage applied to the pixels corresponding to the slits according to a diffracting grating pattern. That is, rather than setting the voltages of all pixels corresponding to a particular slit to the same value, the voltages alternate between high and low values along the length of the region in the SLM corresponding to the particular slit.

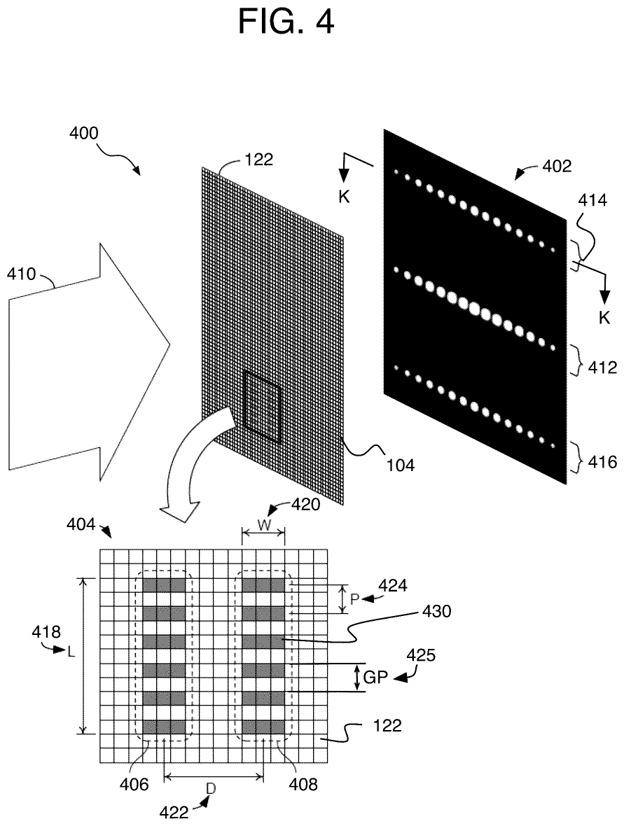

Referring to FIG. 4, an example SLM projection setup 400 may have the example SLM 104 projecting a far-field diffraction or holographic image 402 with the pixels of the SLM controlled according to an example double-slit grating pattern (or slit pair) 404 on a pixel array or layer 122 of the SLM 104. Each square shown in the pixel array 122 is intended to represent a single pixel 123. As used herein, a slit pair 404 may have two separate first and second virtual slits or gratings 406 and 408 that are positioned adjacent one another and dimensioned to correspond to two real parallel slits in a manner similar to the double-slit experiment. Thus, the first grating 406 corresponds to a first slit and the second grating 408 corresponds to a second slit, and the terms slit and grating herein are used interchangeably. Consistent with the double slit experiment, the first and second slits 406, 408 extend parallel to one another in an elongate direction L (418). Further, the individual repeating elements 430 in the slits 406 and 408 also may be referred to as pixels, virtual grooves, or just grooves herein. The elements or grooves 430 extend perpendicular to the elongate direction L of the slits or gratings 406, 408. In this example, the elements 430 each have small groups (e.g., individual pixel rows) of pixels, here being three pixels in this example but could be more or less. The elements 430 have alternating high and low voltages, represented as the phase levels on a phase map, along the length L and applied thereto corresponding to alternating high-low and low-high phase shifts to incident input light 410. Further, in this example, all pixels outside of the narrow slits 406, 408 have a same voltage applied to them, and this voltage may be the same as low voltage pixels within the slits 406, 408. Thus, in the illustrated example, the light (e.g., white) pixels represent pixels associated with a low voltage, whereas the dark (e.g., shaded) pixels represent pixels associated with a high voltage, merely for explanatory purposes. The details of the phase levels are explained below.

While an actual double-slit experiment produces a single order in an interference pattern, due to the slits being mimicked by the slits 406, 408, the far-field diffraction pattern image 402 includes multiple sine wave interference patterns 412, 414, and 416 in the diffraction pattern image 402 that are different orders of diffraction caused by the gratings. Specifically, the far-field diffraction pattern image 402 includes an interference pattern 412 at a 0 order or center location, an interference pattern 414 at a +1 order location, and an interference pattern 416 at a −1 order location. In some examples, additional interference patterns at non-zero (e.g., +/−2, +/−3, etc.) order locations may exist. The center interference pattern 412 at the 0 order position is aligned or centered with the slit pair 404, while the higher order interference patterns are offset in the direction of the elongate length L of the slits 406, 408.

The particular spacing of the separate interference patterns 412, 414, 416 from each other and a particular nature of the sine wave interference patterns 412, 414, 416 is a function of the length 418 L of the slits 406, 408, a width W 420 of the slits 406, 408 (corresponding to the width of slits in a standard double-sit experiment and the width of the elements or grooves 430), a distance D 422 between the slits 406, 408 (corresponding to the distance between slits in a standard double-sit experiment and may be the center-to-center distance), and a pitch P 424 of the groups of pixels within each slit 406, 408 (corresponding to the center-to-center distance between any two most adjacent high voltage groups of pixels or any two most adjacent low voltage groups of pixels in each slit 406, 408). The pitch (P) 424 is a different way of describing the gratings' elements 430 similar to grating periods (GP) 425 that is a repeating pattern of low and high voltage elements or groups of elements, and in turn a repeating pattern of phase levels in a phase level sequence of each grating 406 and 408. In other words, while P is a measure from center to center of the same voltage level groups (low or high voltage), the GP is an end to end measure of a repeating low and high voltage pattern. Both the pitch and the GP are 2 on the slits 406 and 408.

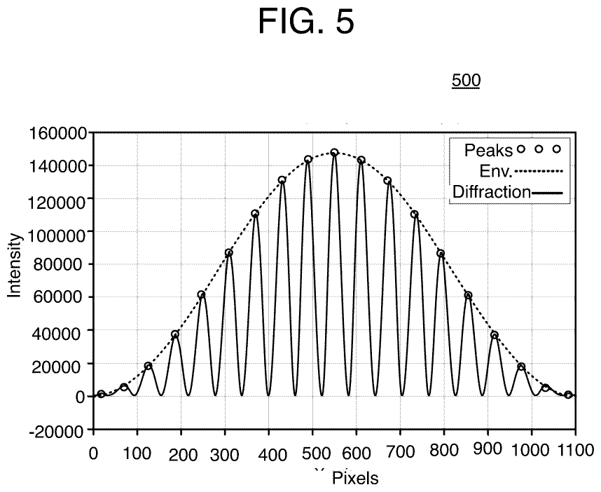

More particularly, the diffraction angle defines or sets the spacing of the different interference patterns 412, 414, 416 and depends inversely on the pitch P 424 and grating period GP 425. Further, since the nature of the alternating high and low intensity interference patterns 412, 414, 416 depends on the length 418, width 420, and spacing (e.g., the distance 422) of the two slits 406, 408 as with a traditional double-slit experiment. Thus, the length 418, width 420, spacing distance 422, and/or pitch 424 and grating period GP 425 of the gratings 406, 408 may be adjusted in any suitable matter. The grating periods GP are adjusted to achieve vibration compensation as described below. A graph of the interference pattern 414 may be taken along cross-section lines K-K for example. FIG. 5 shows a similar interference pattern except FIG. 5 shows a pattern 500 for horizontal gratings and vertical interference patterns rather than the vertical gratings and horizontal interference patterns shown on the diffraction image 402 of FIG. 4. Other than the number of pixels, the shapes of the graphs are very similar.

Also similar to a conventional double-slit experiment, the phase (e.g., location of peak intensity) in the sine wave pattern exhibited in the interference patterns 412, 414, 416 depends on the difference in average phase of each slit 406, 408. Thus, measuring the phase of the interference patterns 412, 414, 416 provides a direct measure of the phase difference between the slits 406, 408. In some examples, the interference patterns 414, 416 are analyzed rather than the zero order interference pattern 412 because the zero order pattern 412 may include parasitic light from sources other than what was diffracted by the double-slit grating pattern 404. For example, the zero order interference pattern 412 may include light from gaps between pixels in the SLM 104 and/or light from the sides of the SLM 104, as well as light from all background pixels (pixels not participating in in any slits). Because the interference patterns 414, 416 at the higher (non-zero) orders are diffracted towards opposite sides of the zero order pattern 412, the higher order interference patterns 414, 416 will not be contaminated by these stray sources of light.

In the illustrated example of FIG. 4, the difference in phase between the slits 406, 408 is more properly characterized as the difference in the average phase of the slits because not all pixels associated with each slit 406, 408 exhibit the same phase delay as a result of applying different (e.g., low or high) voltages to different ones of the pixels. Thus, if the low voltage corresponds to a phase of 0 and the high voltage corresponds to a phase of π, the average phase for each grating or slit 406, 408 should be π/2. If the light incident on the SLM 104 is perfectly uniform, coherent, and collimated, and each pixel is controlled exactly as intended, the difference between the average phase of the two gratings 406, 408 should be zero. However, in practical reality, as described above, there are almost always imperfections in the input light source and imperfections in the control of the pixels of the SLM 104. As a result, there is likely to be some difference in phase of the light output by the two gratings 406, 408, which can be directly measured by measuring the phase of the intensity of light in the interference patterns 412, 414, 416. In this manner, the difference in phase between the pixels associated with the slits 406, 408 can be determined. Stated differently, if the pixels in the first slit or grating 406 have a phase alternating between 0 and π, and the pixels in the second slit or grating 408 have a phase alternating between 0 and π+α, then the observed diffracted sine wave intensity profile in a resulting interference pattern 412, 414, or 416 will be shifted by a phase of α/2. If the pixels in both gratings were set to have alternating phases of 0 and π, then the a represents the amount of error in the input light and/or the SLM.

Also, the difference in average phase between the gratings 406, 408 is specific to the particular gratings at the particular location within the SLM 104. Since the slit pair 404 is much smaller than the entire SLM 104, the double-slit experiment can be repeated multiple times with the slit pair 404 being shifted each time. In an ideal case of a perfectly uniform plane wave illumination incident on the SLM 104 and a perfect SLM, the resulting diffraction pattern produced by any given slit pair 404 at any given X-Y location of the SLM 104 should be the same as the same slit pair 404 at any other location of the SLM 104. As there are almost always imperfections in the input light beam and/or in the SLM itself, stepping the slit pair 404 across the SLM 104, enables the extent of such imperfections across the entire surface of the SLM 104 to be determined.

Referring again to FIG. 5, an example shape of the far-field diffraction or interference pattern 500 may be produced, here for a 1920×1080 pixel SLM from 0 to 1080 (max) pixels for horizontal gratings or slits forming vertical interference patterns, or from 0 to 1920 (max) pixels for vertical gratings or slits forming horizontal interference patterns as in FIG. 4. The interference pattern 500 may be characterized by an apodised sine wave pattern. In some examples, the phase of the sine wave represented in the interference pattern 500 is determined by analyzing an image of the interference pattern 500 captured by the image sensor 130 of FIG. 1. More particularly, in some examples, the phase of the sine wave is determined by taking the fast Fourier transform (FFT) of the signal (e.g., the pixel information along he interference pattern 500), finding the peak frequency component, and then measuring the phase as:

$$δ = a tan ( I mag / Real ) \qquad ( 2 )$$

where Imag is the imaginary portion of a complex number corresponding to the peak frequency bin of the FFT, and Real is the real portion of the complex number corresponding to the peak frequency bin. As mentioned above, a slit pair 404 can be moved to different locations across the SLM 104 to test different regions of the SLM 104 for imperfections. While such tests enable a determination of the phase difference between the pixels associated with the gratings at each particular location, this does not directly define the phase of the pixels relative to a ground truth or even relative to different pixels associated with different locations within the SLM 104. Accordingly, in some examples, the slit pair 404 is moved (or stepped) in a sequence of locations across the SLM 104 in a manner that each subsequent location can be linked or tied to the previous location or a base location until the relative phase of different regions across the entire surface of the SLM 104 can be defined relative to any other region.

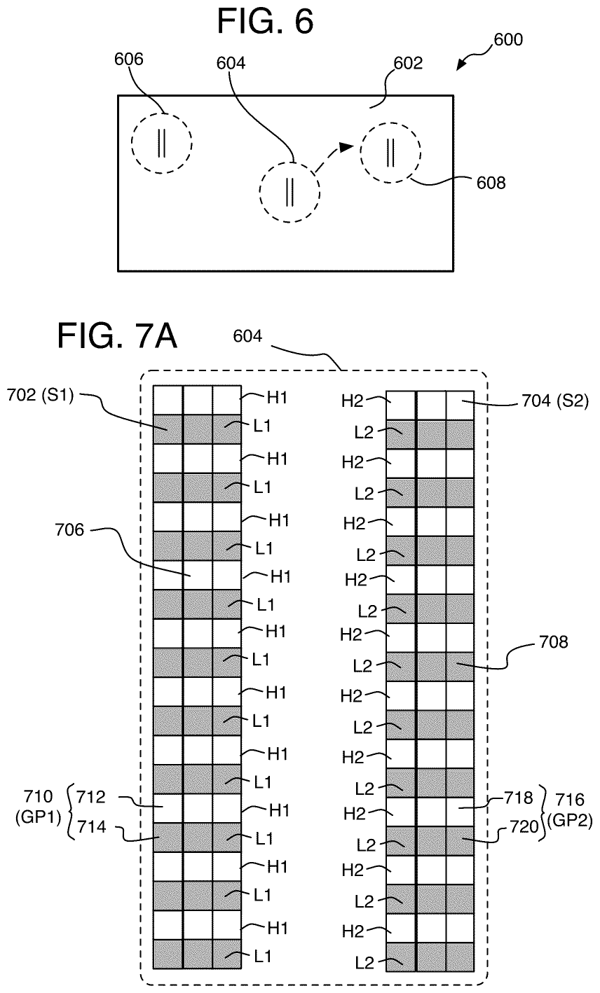

Referring to FIG. 6 for example, an SLM 600 has a pixel array or layer 602, corresponding to a phase map, and has a phase shift measuring slit pair 604 and a reference or vibration slit pair 606 shown relative to a much larger SLM pixel array, such as 1080×1920 pixels.

On a first phase map at a specific location of the measuring slit pair 604, a measuring reference phase difference may be generated to be subtracted from all subsequent measuring slit pair phase shifts at that location. Specifically, a reference phase (Phase 0) for V=0 is established by defining a slit pair 604 with both gratings having voltage pixels values alternating between 0 and 128, such that no intentional phase shift occurs, and then measuring the phase difference as outlined above. This base phase difference may be used as the measuring base or reference phase difference (δ0) that is to be subtracted from all subsequent initial measured phase shifts from subsequent measuring slit pairs 604 at the location of the base phase shift. Once the base phase difference is established, the phase levels may be incremented as described below for subsequent phase shifts at the same location, and, by one form, all subsequent measuring phase shifts could be relative to this first base phase difference at the same location. Each different location of the measuring grating map on the SLM will have its own first base phase difference to subtract from the subsequent phase shifts at the same location. Note, however a single location may have multiple base grating patterns instead and changed every certain number of phase level increments for the same location in order to maintain a certain difference in high and low phase levels to provide a sufficient amount of intensity on the interference patterns. This is explained in greater detail below.

The measuring slit pair 604 may be moved as shown by the dashed arrow to a new location 608, and from phase map to phase map to determine the local phase responses at each location. The measuring slit pair 604 can be iteratively moved to different locations across the SLM 104 and the process repeated until a phase response transfer curve has been defined for every region of the SLM 600.

Since the phase response transfer curve may be determined independently at each location, no limitations exist as to the spacing between each location of the SLM 104 for which a transfer curve is generated. Thus, in some examples, the slit pair 604 may be shifted one pixel at a time, or some other desired pixel increment, and the phase shift determination process is repeated. By one form, the measuring slit pair 604 may be shifted horizontally across the SLM 600 and then upward or downward in a raster manner, or vice-versa in a vertical manner first instead, or some combination of both. The grating pattern also may be rotated so the gratings extend horizontally parallel for one set of phase responses and vertical for another set of phase responses, and the resulting phase responses for the same pixels may be combined (such as averaged). Otherwise, angle-dependent phase responses can be generated instead as described in great detail below.

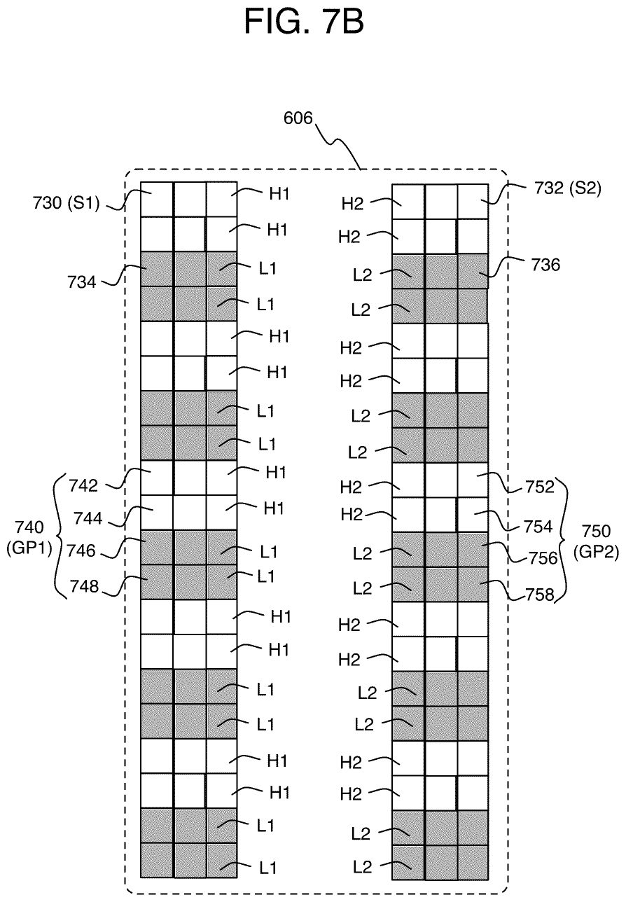

Referring to FIG. 7A, the measuring slit pair 604 has virtual gratings or virtual slits 702 (or S1) and 704 (or S2) forming the gratings. As with slit pair 404 (FIG. 4), slits S1 and S2 are parallel, aligned, and here vertically oriented with a length L and width W located at distance D from each other, and with grating periods of GP1 or GP2. Diffraction efficiency is the ability of the double-slit or slit pair gratings to stir or mix light, and in turn produce higher brightness of an interference pattern. The diffraction efficiency is highest when GP1=GP2, so that one implementation may use the same grating period in both slits of the slit pair designated as GP. Each small square on slit pair 604 is a pixel, and for explanatory purposes herein, the pixels in the left slit are always referred to as slit S1 and pixels in the right slit are always referred to as slit S2. For horizontally aligned slits, S1 will be pixels of the top slit and S2 will be pixels of the bottom slit. Pixels of slit S1 depicted in grey all have a “low” voltage and phase level L1. Pixels of slit S1 depicted in white all have a “high” voltage and phase level H1. Pixels of slit S2 depicted in grey all have a “low” voltage and phase level L2. Pixels of S2 depicted in white all have a “high” voltage and phase level H2. By one form, all pixels of the same designation (L1, L2, H1, or H2) have the same phase level and voltage. In other words, all L1 pixels may have the same phase level, and so forth. BY one example, such a slit pair 604 may be fully characterized by its phase levels {L1, H1, L2, H2} and parameters GP, L, D and W. Typically, parameters L, D, and W are selected beforehand, and fixed during, all measurement sessions on a particular hardware setup. The parameters can be determined by experimentation based on contrast and interference pattern's peak frequency index on captured camera images of the projected interference patterns. Thus, the settings of these parameters will be omitted herein and assumed to be pre-selected. Subsequent descriptions of phase levels and grating periods may use the L1, L2, H1, H2 and GP designations going forward.

By one specific example form, the slits S1 and S2 have the same phase level sequence 706 and 708 respectively. In other words, the phase level sequences 706 and 708 both have a grating period 710 (or GP1) and 716 (or GP2) of 2 with one element 712 (H1) or 718 (H2) with a high voltage and high phase level, and one consecutive element 714 (L1) or 720 (L2) with a low voltage and low phase level. Thus, GP1 has elements H1 and L1, while GP2 has elements H2 and L2. These grating periods GP1 and GP2 are repeated along the length of the slits S1 and S2 as shown. For the measuring slit pair 604, and while the slits S1 and S2 may have the same grating period GP1=GP2, the phase level sequences 706 and 708 have at least one phase level, and in turn at least one voltage, that is different so that the measuring slit pair 604 generates a phase shift. One example setting has L1=0, H1=128, H2=H1 for display and capture, while diffraction patterns may iteratively set L2=0, 1, 2, 3, . . . 255 as one possible example. The details and other variations are provided below.

For example, in order to generate an entire phase response curve, the phase levels, and in turn voltage levels, should be incremented or iterated through the available range of phase levels at each or individual measuring slit pair location on the phase map (or on the SLM). By one form, at each or individual slit pair location, one or first of the slits S1 has base level low and high phase levels, such as L1=0 and H1=128, where the available range of phase levels is N=0 to 255. The base phase levels on slit S1 are kept fixed in this example while the phase levels on the other or second grating or slit S2 are changed. When the phase is kept constant at one of the gratings or slits (e.g. greyscale value is L1=0), and iterated over different phase levels for L2 in the other grating, the actual phase response can be deduced from the shift of the sine wave pattern at the relevant interference pattern on the diffraction pattern image. By one example form, either the high or low phase level, or both, on slit S2 may be incremented. By one form, the increment is 1, but could be higher increments. Many variations exist.

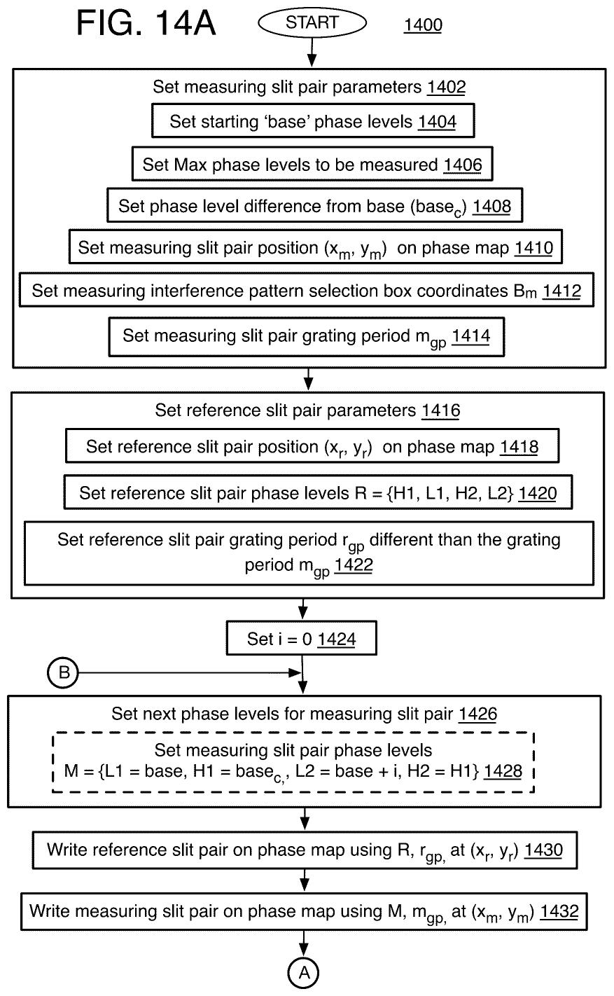

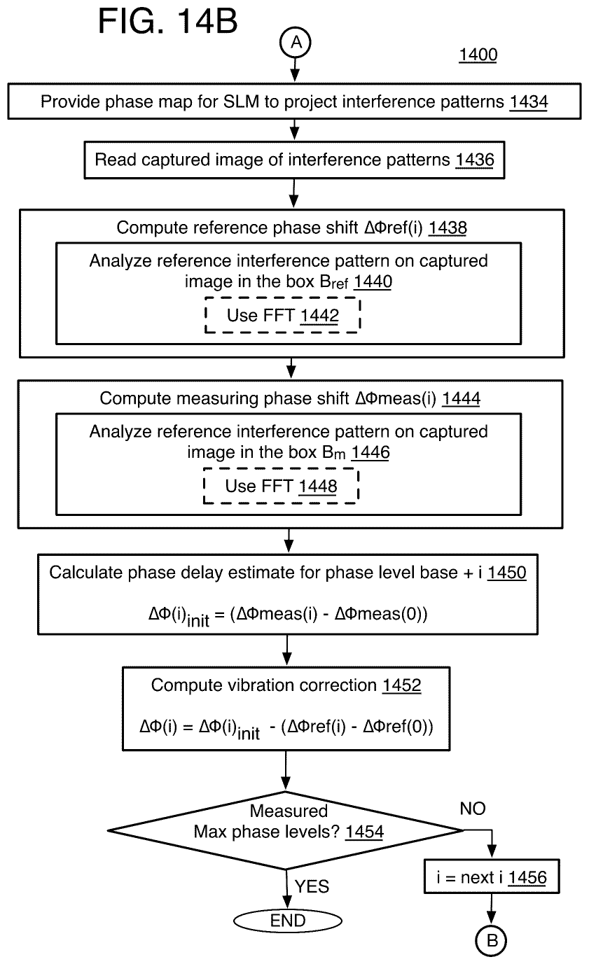

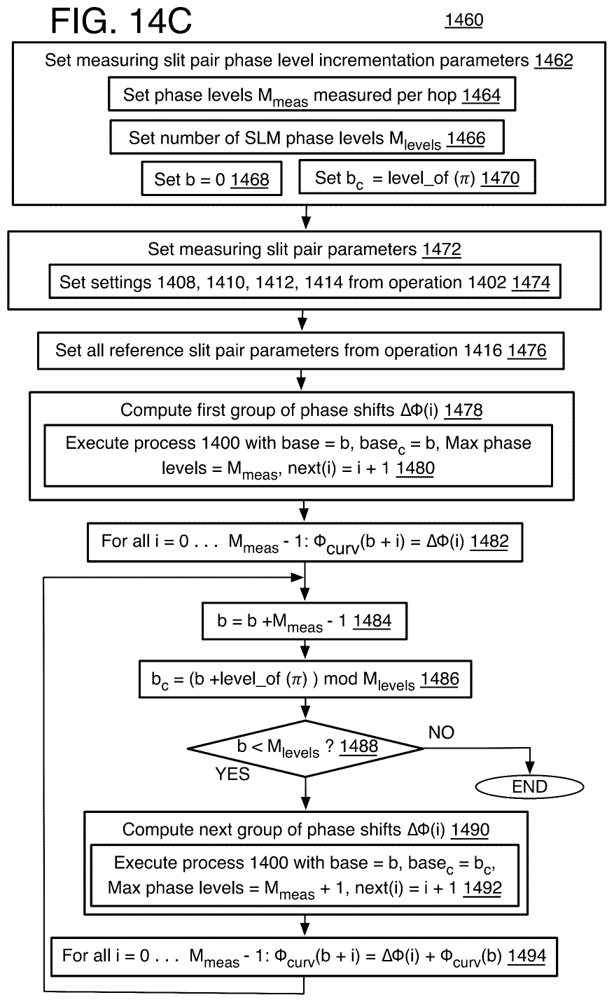

However with regard to the base phase shift, and as mentioned above, the base phase levels on the first grating should not stay the same for comparisons to all subsequent phase levels on the second grating for a single location because the gratings still must generate a sufficient difference (or contrast) in average phase between the two gratings to provide a sufficient brightness to the interference pattern orders that is detectable on the captured interference images. Thus, by one alternative approach, the full phase response curve is reconstructed in a piecewise manner by hopping through several base phase levels at a single grating pattern location and iterating between base, base+1, base+2, . . . base+N. At each hop, at least one of the base phase levels is changed to base+N. By one form, the base phase levels are held constant for 8 to 10 phase level increments (and in turn phase map iterations) when the increment is 1. Then, the base then may be incremented by 8 to 10 in a single step or iteration. One variation of using such base hopping approach to measure a full phase response curve at one location and one angle is provided at process 1460 (FIG. 14C).

By one form, for the 0 to 255 phase level range, the incrementing values, such as the higher voltage values, may be kept at base+128 if 128 is close to π, and N is small. By one form “higher” voltage levels may be kept at (base+128) mod 256 maintaining a high difference between grating grooves automatically.

By one form as to grating periods, the same fixed grating period is used for all phase level increments and all slit pair locations for the measuring slit pairs 604. By another form, the grating periods GP1 and GP2 could change from phase map to phase map as long as it is different from the grating periods on the reference slit pair 606 (described below), and by yet another form, as long as the slit pair 604 produces an interference pattern substantially far from the interference pattern produced by the reference slit pair 606 on a projected diffraction image sufficient for clear phase shift analysis of both patterns.

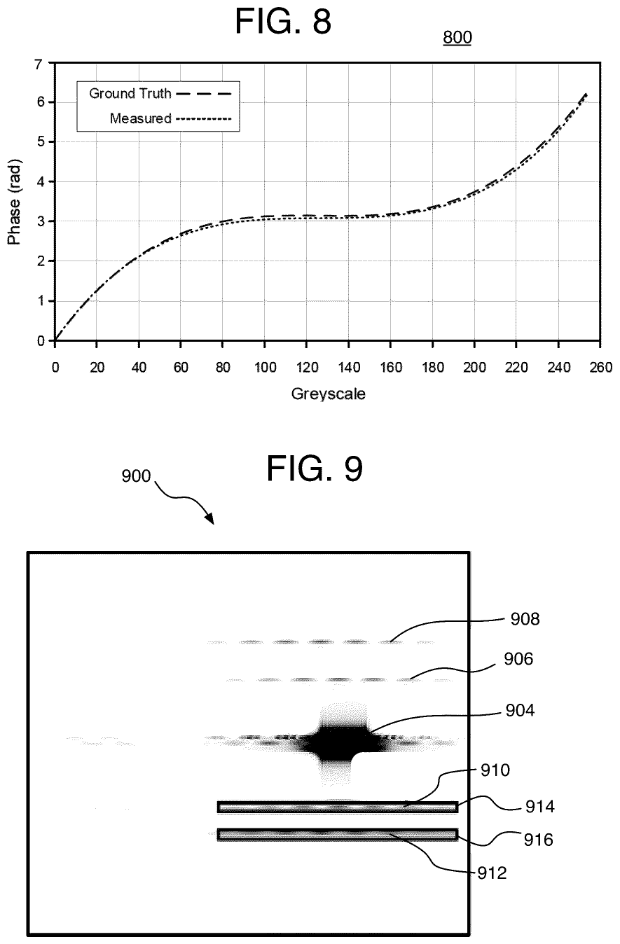

Referring to FIG. 8, an example phase response transfer curve 800 may be generated based on the methodologies disclosed herein using measuring slit pairs described above and relative to known ground truth for the phase response transfer curve. As can be seen, the measured values closely follow the ground truth known phase response. In some examples, the entire set of transfer functions corresponding to all regions across the SLM 104 or 600 are stored in a lookup table or other suitable data structure for retrieval by the SLM control circuitry 102 when generating phase maps, such as greyscale images intended to control the SLM 104 to produce a particular output (e.g., the output wave front 142).

### Vibration Compensation

The holographic arrangement uses relatively large distances to a projection screen 116 (FIG. 1), such as 0.7 to 1.0 meters, and the screen 116 itself can be very large such as 0.5 m×0.5 m. This setup alone can result in vibrations that can affect measurements very significantly as mentioned above, and especially when the incremental base level hopping method is used while moving the measuring slit pair on the SLM pixel surface. This results in the propagation of vibration error from a previous measurement to a next group or sequence of phase maps, and in turn, phase shift measurements.

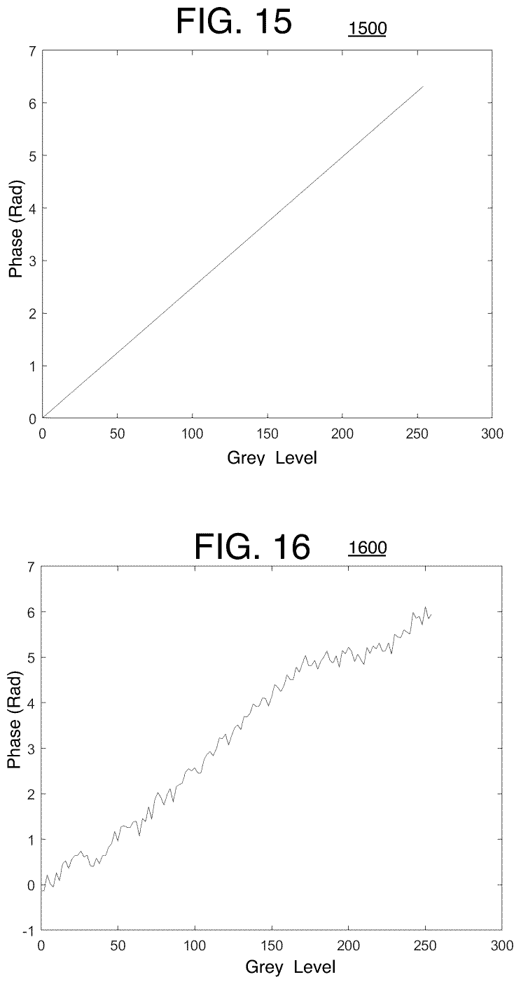

Referring to FIGS. 15-16, a target linear phase response graph 1500 may be compared to an actual graph 1600 that shows a phase response generated using the measuring slit pairs described above and in the presence of large vibrations due to mechanical camera image shifts. The graph 1600 shows the resulting amount of vibration errors erroneously detected as pattern shifts caused by the phase change.

Referring again to FIGS. 6 and 7A-7B, and to compensate for the vibration, a reference or auxiliary (or vibration) slit pair 606 may be fixed in a single location on the SLM 600. The grating pattern 606 remains in the same place from phase map to phase map and does not change during the phase shift measurements. The slit pair 606 may be located anywhere far from the measuring slit pair 604 and, by one example form, not occupying the same rows of SLM pixels for vertically oriented slits or the same columns of SLM pixels for horizontally oriented slits. If, for example, measurement slits are oriented vertically then reference slits can be shifted up or down as far away from the measurement ones as possible. It should be noted, however, that in one form, the reference and measuring slit pairs 604 and 606 remain parallel whatever their locations on the same phase map.

The reference slit pair 606 may have slits 730 designated as left slit S1 and 732 designated as right slit S2 that both have the same phase level sequences 734 and 736 so that no intentional phase shift exists between the reference slits S1 and S2 here. For example, both reference slits S1 and S2 may have phase levels of L1=L2=0 and H1=H2=128. Thus, any shift of the interference pattern of the reference slit pair 606 should be caused by mechanical movements from vibration and that resulted in image shifts. The amount of vibration phase shift can be determined and used to adjust the initial measuring slit pair phase shifts to reduce or remove phase measurement errors to compensate for the vibration.

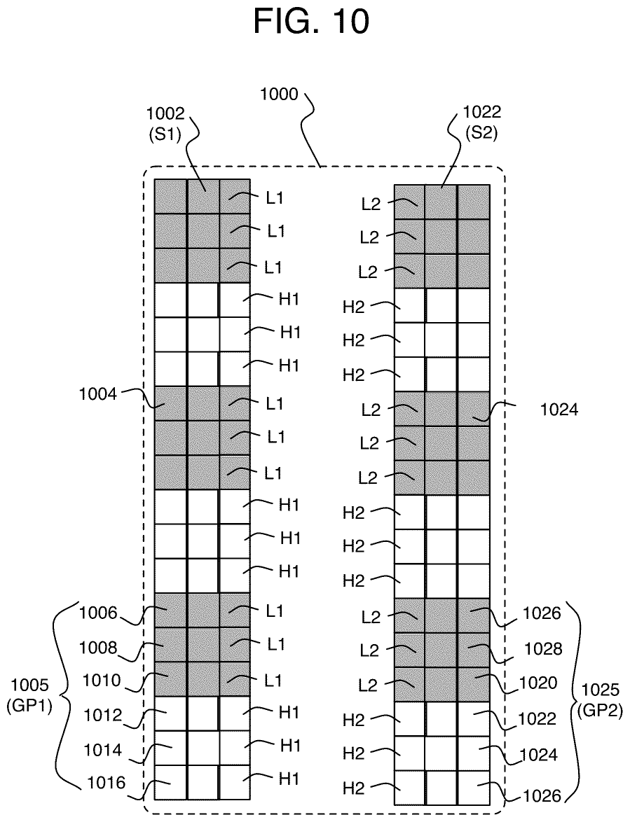

In order to compute accurate reference phase shifts, the reference slit pair 606 may have a different grating period GP than the grating period GP of the measurement slit pair 604 on the same phase map so that intensity images of the two resulting interference patterns do not overlap. One pair of parallel and aligned slits produces a characteristic interference pattern according to the Young experiment formula. If two pairs of slits are positioned in a way that interference between light from pixels from pair 1 with light from pixels from pair 2 is negligible, then a picture with two different characteristic interference patterns will be clearly visible. Specifically, when two slit pairs are on a phase map, and the two slit pairs are separated from each other by a sufficiently large distance in both X and Y directions to minimize the cross-interference, the light pattern projected form the slits will combine additively, as if images of each of the two interference patterns (one from each pair of slits) with multiple orders were added together. In other words, when two pairs of slits are sufficiently separated on the SLM, the interference picture will be dominated by energy from pairwise interference of the slits from both of the pairs and should be visible to a camera as two distinctive interference patterns (shown here on FIG. 9 described below). This is the same with slit pairs 604 and 606 used herein. When pairs of slits are identical in size and phase levels, their corresponding interference patterns will be separated only by the physical distance between pairs of slits on the SLM. Since SLMs are typically small, visual separation of identical interference patterns at large distances is insufficient in practice, so one implementation can use gratings of different grating periods in different pairs of slits to achieve better separation of interference patterns.

Referring again to FIGS. 6, 7A-7B, and 9, the grating period is a key parameter for setting the diffraction angles of the grating. Thus, by providing the reference slit pair 606 with a different grating period than the measuring slit pair 604, the two pairs will produce two interference patterns that are sufficiently separated and suitable for capturing with a camera. This permits separate phase measurement of the two grating pattern pairs even though both patterns are on the same phase map and project to the same diffraction pattern image 900. Thus, for example, even though diffraction pattern image 900 shows a very bright interference pattern 904 at a 0-order with very bright parasitic light that cannot be used to determine phase responses accurately, +/−1^{st}-order positions of the interference patterns 906 and 910 of the measuring slit pair 604 can be used to measure phase response on the measuring slit pairs, while the +/−1^{st}-order positions of the interference patterns 908 and 912 produced by the second (reference) slit pair 606 still can be used to measure reference or vibration error phase responses since the interference patterns 906 and 910 do not overlap the interference patterns 90 and 912.

As shown on FIG. 7B, the reference or vibration grating pattern 606 has phase level sequences 736 and 738 respectively for slits S1 and S2 and that both have the same phase levels and the same grating period 740 and 750 (GP1=GP2). The grating period here is different than the grating period 710 and 716 on the measuring slit pair 604. The grating period 740 on slit S1 is 4 with two consecutive high voltage H1 phase levels at elements 742 and 744 adjacent to two consecutive low voltage L1 phase levels at elements 746 and 748. Grating period 750 on slit S2 also is 4 with a similar arrangement of H2 and L2 phase levels as that of grating period 740. The grating periods are repeated along the length of slits S1 and S2 as shown. As mentioned, the difference between grating periods from slit pair 604 to slit pair 606 will permit the reference slit pair 606 to produce an interference pattern spatially separated from that produced by the measuring slit pair 604.

Referring to FIG. 10 for another alternative, a reference slit pair 1000 has slits 1002 (S1) and 1022 (S2) respectively with phase level sequences 1004 and 1024 and with a grating period of 6 (1005 and 1025). Slit S1 has grating period 1005 with a group of pixels with three consecutive low voltage L1 phase levels at pixels (or pixel rows) 1006, 1008, 1010 adjacent or consecutive to a group of three consecutive high voltage H1 phase levels at pixels or pixel rows 1012, 1014, 1016. Grating period 1025 is similar, and both periods are repeated along the length of the slits. By one form, other grating periods could be used as well that are larger than 6. Thus, herein, the measuring grating period may be 2 while the reference grating period may be 4 or 6. Other variations of grating period combinations among 2, 4, and 6 may be used as well, or higher grating periods may be used, as long as the grating periods of the reference and measuring slit pairs are different.

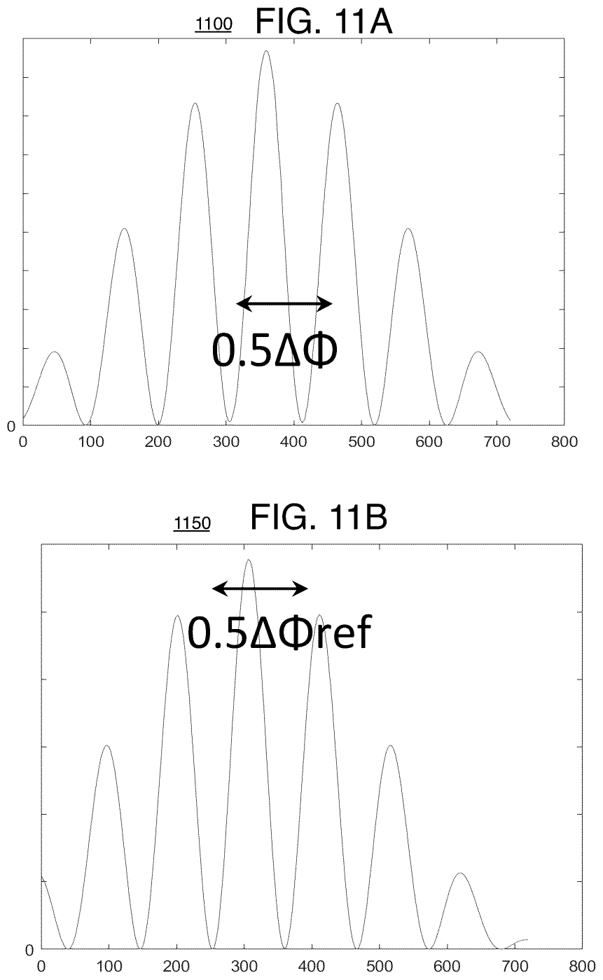

Referring to FIGS. 11A-11B, graphs 1100 and 1150 show example computed phase shifts 0.5ΔΦ(i) and 0.5ΔΦref(i), using interference patterns 910 and 912 respectively for the measuring and reference slit pairs. Thereafter, the vibration or reference phase shift may be subtracted from an initial measuring phase shift (already subtracted from the measuring base phase shift) of the same phase map, and then matched to the voltages used to generate an accurate vibration-compensated phase response transfer curve.

However, before such vibration subtraction, the reference phase shift also should be adjusted in order to factor initial vibration as well as interference pattern selection window or box tolerances. Specifically, an initial vibration may be exhibited by a first base reference phase shift generated by a reference slit pair on a first phase map. This initial vibration phase shift may be subtracted from all subsequent reference phase shifts from subsequent phase maps so that any subsequent vibration phase shift is relative to the initial unknown vibration phase shift. Initial reference phase shift is measured at the same time (on the same camera image) as the measuring base level phase shift. So initial reference phase shift includes:

reference box shift+frame 0 vibration shift.
For each subsequent camera image i, the reference phase shift may be:

reference box shift+frame i vibration shift.
Subtracting the initial reference phase shift from all reference measurements will result in cancellation of the unknown shift with respect to the selection box. So adjusted (after such subtraction), reference phase shift will be just:

frame i vibration shift−frame 0 vibration shift.
While the measuring phase shift might have different unknown measuring box shifts, it will have the same frame vibration shift since the box shift and measuring shift are on the same camera image. So measuring phase will include:

measuring box shift+frame i vibration shift+slit phase difference i shift
Subtracting the measuring phase shift for frame 0 and adjusted phase difference may be calculated as:

(frame i vibration shift−frame 0 vibration shift)+(slit phase difference i shift−slit phase difference 0 shift).
Subtracting adjusted reference shift from each corresponding adjusted measuring shift will result in vibration term cancellation leaving only:

(slit phase difference i shift−slit phase difference 0 shift)
which can be used as a measure of phase modulation if it is assumed slit phase difference 0 is zero during hologram computations. Such assumption will introduce the same constant phase shift for all pixels in the hologram which doesn't affect the resulting image. An example flow chart on FIGS. 14A-14B applies the adjustments described above to estimate a series of phase differences.

Regarding the box tolerances and FIG. 9 again, once the image data of a captured image of an interference pattern 900 is received, the slit pair interference patterns are selected for analysis. This may involve placing a box or selection window 914 and 916 shown in white around the orders 910 and 912 on an image of the interference pattern to be analyzed. The placement of the boxes may be manual by a user using a graphical unit interface (GUI), such as a mouse, or may be performed automatically by the program to compute the phase shifts. Since the phase shift of the order is based on the amplitude at a peak frequency, the size of the selection boxes is not considered critical by the programs. Thus, in either selection technique, the program often assumes the boxes are of the same size (e.g., the same pixel length, the same pixel coordinates which are saved, etc.), for a given grating period on the reference slit pair and at least for the phase maps with the measuring slit pairs at the same location on the phase maps. This may generate a set of box coordinates with one for each grating period being used. The box coordinates are not always exact, however, because it is impossible to align the box to an exact “beginning” of the interference pattern's sine wave period. Even though a box location is inexact in this sense, the phase shift computation program uses the adjustment procedures described above to eliminate the need for precise alignment.

Thus, in order to factor the initial vibration from the first reference slit pair on the first phase map as well as the window or box selection tolerance or misalignment, the base or anchor phase shift (i=0) of the first reference slit pair of the first phase map is subtracted from an initial reference phase shift (i) on subsequent phase maps to generate a reference phase shift to be subtracted from the measuring phase shift on the same phase map. Other details are provided below in the processes 1300 and 1400 for compensating for vibration.

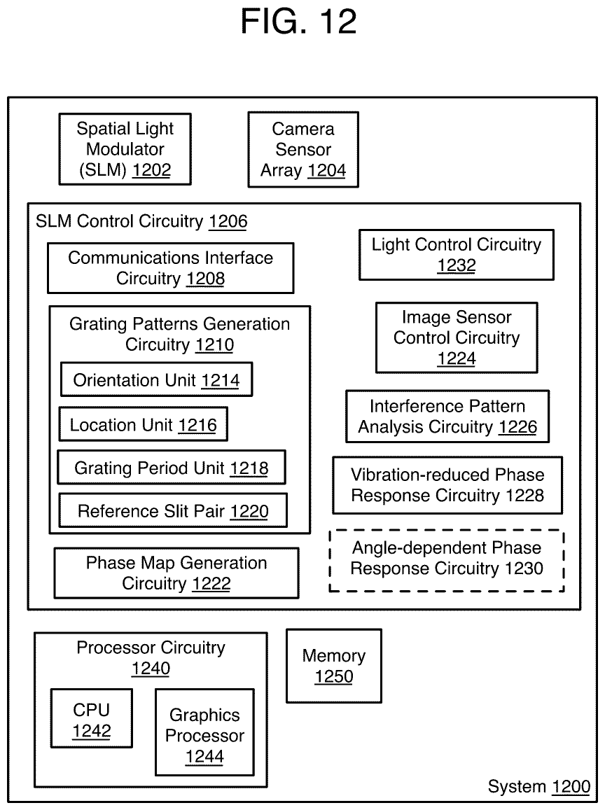

Referring first to FIG. 12 preliminarily, an example system 1200 implements the holographic arrangement 100 of FIG. 1 and may be used to operate the processes described below. The system 1200 has an SLM 1202, a camera sensor array 1204, SLM control circuitry 1206, processor circuitry 1240, and memory 1250. The components herein with the same name as components of arrangement 100 or other arrangements, devices, or systems herein have at least some of the same functions, but may perform more tasks than the titles suggest. Processor circuitry 1240, camera 1204, SLM control circuitry 1206, and/or memory 1250 may be capable of communication with one another, via, for example, a bus, wires, wireless, or other access. In various implementations, these components of system 1200 may be integrated in a single device 1200 or implemented separately in a number of devices.

The SLM 1202 is as described with SLMs 104, 204, 306, 600, and/or 1902. The camera sensor array 1204 may be at least one Basler acA4112-30 μm with 70 mm lens camera and may be used with parameters such as global shutter, 50 mm-70 mm lens, 10MP resolution or higher, with 3.45 μm pixel pitch sensor or smaller, with the exposure interval fitting inside the SLM frame interval (e.g. 1/60s), with hardware trigger if possible. Many variations are possible. By one form, the camera or sensor(s) should be selected so that as many camera image pixels as possible or practical cover both periods of the measuring interference pattern (e.g. 910) and the reference interference pattern (e.g. 912) on the same diffraction pattern image 900 (FIG. 9), while maintaining sufficient periods visible in the camera image for the FFT analysis described earlier.

The SLM control circuitry 1206 may include example communications interface circuitry 1208, example slit pair generation circuitry 1210, example phase map generation circuitry 1222, example image sensor control circuitry 1224, example interference pattern analysis circuitry 1226, example vibration-compensated phase response circuitry 1228, and optionally example angle-dependent phase response circuitry 1230 as well as light control circuitry 1232.

The example communications interface circuitry 1208 enables communications between the SLM control circuitry 1206 and other components in the system 1200. For instance, in some examples, the SLM control circuitry 1206 communicates with the light control circuitry 1232 via the communications interface circuitry 1202. In other examples, the SLM control circuitry 1206 and the light control circuitry 1232 operate independently without communicating with one another. Further, in some examples, the SLM control circuitry 1206 uses the communications interface circuitry 1202 to communicate with (e.g., send control commands and/or phase levels or images 132) to the SLM 1202. In some examples, the SLM control circuitry 1206 uses the communications interface circuitry 1202 to communicate with the image sensor array 1204 to, for example, send commands that cause the image sensor 1204 to capture an image (e.g., of the far-field diffraction pattern 402 of FIG. 4). Further, the SLM control circuitry 1206 receives images captured by the image sensor 1204 via the communications interface circuitry 1208. Although the communications interface circuitry 1208 is represented by a single unit in FIG. 12, in some examples, the communications interface circuitry 1208 includes multiple separate interfaces (e.g., one interface to communicate with the SLM 1202 and a separate interface to communicate with the image sensor 1204).

The example slit pair generation circuitry 1210 may have parameters for a slit pair or double-slit gratings pattern, and has an orientation unit 1214, a location unit 1216, a grating period unit 1218, and a reference slit pair unit 1220 to perform the tasks related to the title of the unit and as described above. The slit pair generation circuitry 1210 generates both the reference and measuring double-slit gratings patterns and that are placed in a phase map by the phase map generation circuitry 1222.

The example image sensor control circuitry 1224 generates and/or provides commands and/or instructions to the image sensor 1204 to control the operation of the image sensor 1204. For instance, in some examples, the image sensor control circuitry 1232 causes the image sensor 1204 to capture an image of a far-field diffraction interference pattern. The example interference pattern analysis circuitry 1226 analyzes the images captured by the image sensor 1204. More particularly, when a captured image includes a diffraction interference pattern, the interference pattern analysis circuitry 1226 analyzes orders in the interference patterns to determine a phase of the orders.

The example vibration-reduced phase response circuitry 1228 generates phase response transfer curves or functions as described above and based on the phase difference measurements of the interference pattern analysis circuitry 1226.

As will be appreciated, the units or components illustrated in FIG. 12 may include a variety of software and/or hardware modules, and/or modules that may be implemented via software or hardware or combinations thereof. For example, the modules may be implemented as software running on the processor circuitry 1240, or the modules may be implemented via a dedicated hardware portion as named by the module or unit. Furthermore, the shown memory 1250 may store any data related to generating phase responses described herein. Memory 1250 may be shared memory for processing of the units or circuitry of the SLM control circuitry 1206, such as to store phase map data, captured interference image data, phase data, phase shift data, and/or phase responses, as well as any intermediate data versions needed to form any of this data.

Also, system 1200 may be implemented in a variety of ways. For example, the circuitry of system 1200 may be implemented as a single chip or device having a graphics processor unit (GPU 1244), an image signal processor (ISP), a quad-core central processing unit 1242, and/or a memory controller input/output (I/O) module. In other examples, system 1200 may be implemented as a chipset or as a system on a chip (SoC).

Processor circuitry 1240 may include any suitable implementation including, for example, microprocessor(s), multicore processors, application specific integrated circuits, chip(s), chipsets, programmable logic devices, graphics cards, integrated graphics, general purpose graphics processing unit(s), or the like. In addition, memory 1250 may be any one or more types of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 1240 also may be implemented via cache, internal, on-board, on-chip, or local memory.

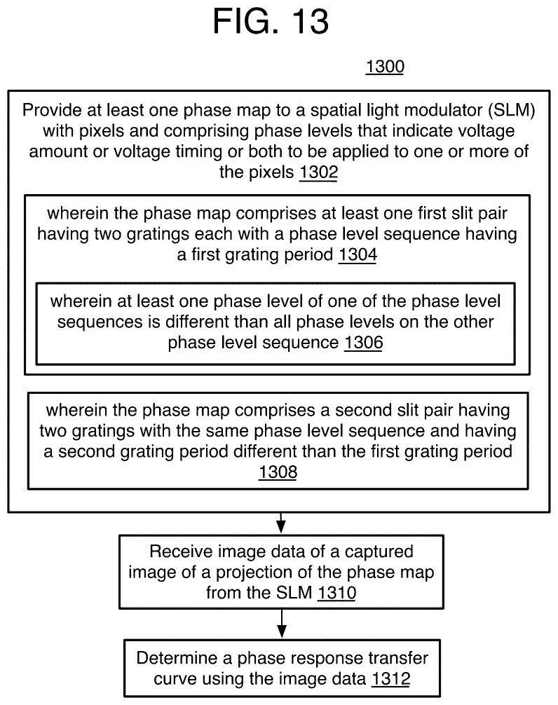

Referring now to FIG. 13, a process 1300 of spatial light modulator calibration with vibration compensation is arranged in accordance with at least some implementations of the present disclosure. In the illustrated implementation, process 1300 may include one or more operations, functions or actions as illustrated by one or more of operations 1302 to 1312 generally numbered evenly. By way of non-limiting example, process 1300 may be described herein with reference to example devices, systems, or arrangements 100, 200, 300, 400, 600, 1200, 1900, 2300, or 2400 of FIGS. 1-4, 6, 12, 19, 23, and 24 respectively, and as discussed herein.

Process 1300 may include “provide at least one phase map to a spatial light modulator (SLM) with pixels and comprising phase levels that indicate voltage amount or voltage timing or both to be applied to one or more of the pixels” 1302. This involves receiving a phase map with pixel values that indicate a phase associated with a voltage amount or timing. By one example, the phase map be a greyscale image of pixel values 0 to 255 or other pixel color or value type of scheme.

Process 1300 may include “wherein the phase map comprises at least one first slit pair having two gratings each with a phase level sequence having a first grating period” 1304. Here, the first slit pair may be the measuring slit pair described above. By one form, the grating pattern may have a grating period of 2 with a repeating pattern of low and high voltage phase levels. A grating period has one or a group of consecutive low phase level elements adjacent or consecutive to another one or another group of consecutive high phase level elements repeating within a phase level sequence along a single grating. High and low phase levels merely refers to higher or lower than the other (high or low) phase levels.

Process 1300 may include “wherein at least one phase level of one of the phase level sequences is different than all phase levels on the other phase level sequence” 1306. Thus, the first slit pair has a difference in phase levels on its two gratings at least sufficient to form a phase shift of sufficient intensity that it is visible on an interference pattern. By one form, one of the high or low phase levels in one grating is kept the same as in the other grating, while the other of the high and low phase levels is incremented. Many variations can be used.

Process 1300 may include “wherein the phase map comprises a second slit pair having two gratings with the same phase level sequence and having a second grating period different than the first grating period” 1308. Here, the reference or vibration slit pair may have a grating period larger or otherwise different than the grating period of the first slit pair so that both first and second slit pairs will have interference patterns on a diffraction pattern image that do not overlap at least sufficiently so that both interference patterns can be analyzed to determine a separate phase shift of each interference pattern. By one form, the second grating period is 4 or 6 while the first grating period is 2. By another form, the second grating period is 2, 4, 6, or other value as long as it is different than the first grating period, or as long as the first grating period is smaller than the second grating period. By one form, the second slit pair remains in the same fixed position on multiple or all phase maps being analyzed.

Process 1300 may include “receive image data of a captured image of a projection of the phase map from the SLM” 1310. This may involve receipt by SLM or other circuitry that can analyze the interference patterns from a diffraction pattern image that is the projection of the phase map and captured on the captured image, such as by a camera or other sensors.

Process 1300 may include “determine a phase response transfer curve using the image data” 1312. This involves a number of operations detailed herein. Since both the measuring and reference slit pairs were on the same phase map, two different interference patterns on the diffraction pattern image (captured image) can be analyzed to provide the separate phase shifts of the measuring and reference slit pairs. A version or form of the reference phase shift can be subtracted from a version or form of the measuring phase shift to determine a vibration-compensated phase shift. Both an initial measuring slit pair and an initial reference slit pair respectively may be adjusted to factor an unknown base or initial measuring phase shift and a base reference phase shift, respectively. The vibration-compensated phase shift then can used to generate the phase response transfer curve for a phase map.

Referring now to FIGS. 14A-14B, a process 1400 of spatial light modulator calibration with vibration compensation is arranged in accordance with at least some implementations of the present disclosure. In the illustrated implementation, process 1400 may include one or more operations, functions or actions as illustrated by one or more of operations 1402 to 1456 generally numbered evenly. By way of non-limiting example, process 1400 may be described herein with reference to example devices, systems, or arrangements 100, 200, 300, 400, 600, 1200, 1900, 2300, or 2400 of FIGS. 1-4, 6, 12, 19, 23, and 24 respectively, and as discussed herein.

Preliminarily, the setup of the holographic arrangement may include placing a light source and optical elements to emit light to the SLM, placing a projection screen in front of the SLM at a certain far-field distance (such as 0.7 to 1.0 meters) to show interference patterns, and placing a camera or image sensors to capture diffraction pattern images projected onto the screen. The camera may be communicatively connected to a computer for programmatic trigger of an image capture. These components should be placed on supports and secured in place to prevent movement and as securely as is practical. This setup may be performed for calibration before run-time use for each holographic or other device with a phase SLM to be used to display images or otherwise obtain image data from a projection from the SLM.

As another preliminary matter, the process 1400 below may be repeated for each different location of a measuring slit pair on a phase map. The location incrementation is discussed elsewhere herein.

Process 1400 may include “set measuring slit pair parameters” 1402, and this may include “set starting ‘base’ phase levels” 1404. This refers to setting the first or base phase levels L1, L2, H1, H2 for the first measuring slit pair at a specific location on the phase map. By one form, L1=L2=0, and H1=H2=128 for a greyscale phase map phase level range of 0 to 255 (for 256-level SLM). Many variations may be used.

Set the measuring slit pair parameters 1402 may include “set Max phase levels to be measured” 1406. By one form, this is 255 for measurement of the full greyscale 256-level range available, but could be lower when it is not desired to measure the entire range. Other ranges may be used when other image data schemes are being used.

Set the measuring slit pair parameters 1402 may include “set phase level difference from base (base_{c})” 1408, where base_{c} also refers to base_contrast. This is the minimum difference between the high and low pixel levels to be maintained in the same slit. In other words, the difference between L1 and H1 in slit S1, or L2 and H2 in slit S2, which is set large enough to form a phase difference with all base+i sufficient to generate an interference pattern with enough intensity to be analyzed for a phase shift.

Set the measuring slit pair parameters 1402 may include “set measuring slit pair position (xₘ,yₘ) on phase map” 1410. This may be a predetermined order from left to right, and then down and so forth. The location increments may be fixed at 1 pixel or more, in one or more directions, such as horizontal or vertical or both. By one form, the location increments so that all areas or pixels of a phase map have phase shift levels for a phase response, whether by direct measurement or interpolation. By one form, the location increments may vary depending on the part of the phase map, such as edges versus middle.

Set the measuring slit pair parameters 1402 may include “set measuring interference pattern selection box coordinates Bₘ” 1412, and these may be set in camera image pixel coordinates. The box is set at the general area expected to have the measuring interference pattern on the captured images, and may be determined by experimentation.

Set the measuring slit pair parameters 1402 may include “set measuring slit pair grating period m_{gp}” 1414 Bₘ. Here, the grating period of the measuring slit pair may be 2, although other values may be used as long as it is different than the grating period of the reference slit pair. By one form, the measuring slit pair grating period is less than the grating period of the reference slit pair. The grating periods should be sufficiently different so that the measuring and reference interference patterns are sufficiently spatially separated on the projection screen to permit phase shift measurement on an interference pattern of both of the interference patterns involved.

Process 1400 may include “set reference slit pair parameters” 1416, and this may include “set measuring slit pair position (xᵣ, yᵣ) on phase map” 1418. By one form, the reference slit pair may be placed nearer a corner of the phase map than the measuring slit pair when the measuring slit pair is closer to the SLM center. The reference slit pair may be placed as far away from the measuring slit pair as possible, and by one form, is not aligned with the measuring slit pair along the slits' orientation direction (e.g., the slits of the reference and measuring slit pairs are not extending lengthwise in the same pixel columns or pixel rows of the phase map). The reference and measuring slit pairs, however, should extend in parallel in one example.

Set reference slit pair parameters 1416 may include “set reference slit pair phase levels R={H1, L1, H2, L2}” 1420. The gratings of the reference slit pair should have the same phase level sequences on both slits (such as L1 and L2 at zeros and H1 and H2 at 128 s for a 0 to 255 range or 256-level SLM) so that no intentional phase shift is created and the only phase shift that exists should be from vibration. By one approach, “low” L1 and L2 is set at a some_level, while “high” H1 and H2 is set at (some_level+128) mod 256 (for 256-level SLM).

Set reference slit pair parameters 1416 may include “set reference slit pair grating period r_{gp} different than the grating period m_{gp}” 1422. As mentioned, the reference slit pair grating period should be different than the measuring grating period, such as 4 or 6 when the measuring grating period is 2, although other variations can be used.

Process 1400 may include “set i=0” 1424, and this starts a counter for iterations (or increments of phase maps) for a single measuring slit pair location.

Process 1400 may include “set next phase levels for measuring slit pair” 1426. This may include “set measuring slit pair phase levels M={L1=base, H1=base_{c}, L2=base+i, H2=H1}” 1428, which shows one example phase level technique. Any of the phase level incrementing techniques mentioned herein may be used, including fixing the phase levels of L1 and/or H1 elements of a base slit S1 while incrementing the L2 and/or H2 elements in the second slit S2. By one example form as shown above with M={ }, a first slit S1 has L1 “low” pixels set to the base value, while H1 “high” pixels are set to (base+128) mod 256 (for 256-level SLM), or more generally base_contrast (base_{c}) value. The second slit S2 may have the L2 “low” pixels set to base+i, while the H2 “high” pixels are set equal to H1 (i.e., (base+128) mod 256 or base_{c}). It should be noted that the base_{c} value must be selected to have large enough phase difference with all base+i, where i in this paragraph may equal=0 and all next i produced by step 1456. In other words, for all phase levels measured in a particular invocation of the process FIG. 14A. Otherwise, any variation may be used as long as intensity of the interference patterns allows for phase shift measurement for both the measuring and reference slit pairs and grating periods are sufficiently different from reference slit pair to measuring slit pair so that the interference patterns do not significantly overlap.

Process 1400 may include “write reference slit pair on phase map using R, r_{gp} at (xᵣ,yᵣ)” 1430, where the phase map data will be written to include the grating phase levels R according to the grating period rep and at the specified coordinates of the measuring slit pair. The coordinates may be a corner or other key location of the slit pair, and the slit pixels on the phase map may be populated with phase levels accordingly relative to the coordinates.

Process 1400 may include “write measuring slit pair on phase map using M, m_{gp} at (xₘ,yₘ)” 1432, where similar to the reference slit pair, the phase map data here may be written to include the grating phase levels M according to the grating period m_{gp} and relative to the specified coordinates of the measuring slit pair. The coordinates may be a corner or other key location of the slit pair, and the pixels on the phase map may be populated with phase levels accordingly relative to the coordinates. The remainder of the phase map may be set at a background phase level, which may or may not be the same as either of, or the lowest of, the low voltage L1 and L2 phase levels.

Process 1400 may include “provide phase map for SLM to project interference patterns” 1434, where the example communications interface circuitry 1208 may provide the phase map, in the form of drive signals from the SLM, with the measuring and reference slit pairs to the SLM 104.

Process 1400 may include “read captured image of interference patterns” 1436. Here, the SLM modulates and projects the phase map into an image with interference patterns on a far-field screen. The camera can then be automatically triggered to capture the captured (or trial or calibration) image. The captured image data may be held in a memory.

Process 1400 may include “compute reference phase shift ΔΦref(i)” 1438, and this may include “analyze reference interference pattern on captured image in the box B_{ref}” 1440. The measurement of the reference phase shift proceeds with analysis of the relevant interference pattern on the captured image. FFT may be used 1442 (equation (2) above) to determine the amplitude at a peak frequency of the apodised sine wave of the reference interference pattern in the box B_{ref}. The amplitude is the phase of the sine wave and is a direct measurement of the phase difference or phase shift between gratings of a slit pair.

Process 1400 may include “compute measuring phase shift ΔΦmeas(i)” 1444, which is the similar process described above to analyze the reference interference pattern using FFT in operations 1438, 1440, and 1442, but here to compute the measuring phase shift in operations 1446 and 1448 with the measuring interference pattern in box Bₘ. BY one approach, the computed measuring phase shift ΔΦmeas(i) still needs to be adjusted relative to the measuring base slit pair of the current location.

Thus, process 1400 may include “calculate phase delay estimate for phase level base+i” 1450, where here the adjusted or initial measuring phase shift is computed by subtracting the first or base measuring phase shift from the non-adjusted measuring phase shift for the current iteration i and for the current measuring slit pair location:

$$Δ {Φ ( i )}_{init} = Δ Φ m e a s ( i ) - {Δ}_{φ} m e a s ( 0 ) \qquad ( 3 )$$

The phase delay estimate (or initial measuring phase shift) ΔΦ(i)ᵢₙᵢₜ still includes vibration errors. Thus, process 1400 may include “compute vibration correction” 1452. This first involves adjusting vibration phase shift for selection box tolerance and/or initial vibration. Here, the first reference or vibration base phase shift ΔΦref(0) from the first reference slit pair on the first phase map from all subsequent reference phase shifts on the subsequent phase maps is obtained from memory for example. The first or base phase shift is subtracted from the current reference phase shift ΔΦref(i). Finally, the initial measuring phase shift is corrected to form a vibration-compensated measuring phase difference ΔΦ(i) as follows:

$$Δ Φ ( i ) = Δ {Φ ( i )}_{init} - ( ΔΦ ref ( i ) - ΔΦ ref ( 0 ) ) \qquad ( 4 )$$

Process 1400 may include the inquiry “measured Max phase levels?” 1454. If so, the phase response transfer curve is generated and stored, such as in a look-up table, for the current location. If the measuring slit pair is to be analyzed at a new location, the process is repeated from operation 1402. Otherwise, if the Max was reached on the final location of the measuring slit pair on the phase map, the example process of FIG. 14 ends.

If the Max phase level is not reached yet, process 1400 may include “i=next i” 1456, where i is incremented and the process loops back to operation 1426 to change phase levels on the measuring slit pattern and continue the phase analysis at the same location. The increment i may be incremented automatically such as by i=i+1 or i+2, and so forth for whatever the increment amount is to be. By one option, this may incorporate the base hopping technique mentioned above. Otherwise, the incrementation value may be obtained from a list in memory, and may be 0, 8, 7, 6, 5, 4, 3, 2, 1, for example.

Referring to FIG. 14C, an optional process 1460 is a specific example implementation of process 1400, and specifically to measure data to generate a phase response transfer curve (or just phase response curve). By one form, process 1460 may generate an entire phase response, and while using an example implementation of the base hopping technique described above. The process estimates pieces of the response curve iteratively by employing the process 1400.

Process 1460 may include “set measuring slit pair phase level incrementation parameters” 1462. This setting operation 1462 includes “set phase level Mₘₑₐₛ measured per hop” 1464, By one form, Mₘₑₐₛ is the number of iterations (and in turn, phase maps) that the base slit (S1) (although it could be S2 instead) described above for example has its grating phase levels L1 and H1 fixed and while the measuring slit pair is at a single phase map location. By one form, Mₘₑₐₛ is 8 to 10, although any other value may be used that is determined to be adequate by experimentation.

The setting operation 1462 also may include “set number of SLM phase levels Mₗₑᵥₑₗₛ” 1466, and this refers to the maximum number of phase levels handled by the SLM, such as 256 for an SLM handling 0 to 255 greyscale levels for example.

The setting operation 1462 also may include “set b=0” 1468, which is a base slit phase level increment counter to determine when the phase levels L1 and H1 of the base slit should be incremented.

The setting operation 1462 also may include “set b_{c}=level_of (π)” 1470, where b_{c} is a base contrast in phase levels to maintain the minimum difference between the high and low pixel levels to be maintained in the same base slit for adequate interference pattern intensity. The level_of (π) term is a level of an approximation of a phase difference for the count in radians (or other unit), such as π radians, which may or may not be the same as Mₗₑᵥₑₗₛ/2, or may be set at some other value contrasting to b=0 in phase.

Process 1460 may include “set measuring slit pair parameters” 1472, and this may include the operation “set settings 1410, 1412, 1414 from operation 1402” 1474. This operation may include setting the slit pair position or coordinates 1410, the interference pattern selection box 1412, and the slit pair grating period 1414. The setting of the base 1404, base_{c} 1406, and Max phase level 1408 are skipped for this implementation and replaced with settings herein in process 1460.

Process 1460 may include “set all reference slit pair parameters from operation 1416” 1476, and including all of the settings from operation 1416.

Process 1460 then may include “compute first group of phase shifts ΔΦ(i)” 1478. This operation 1478 may include “execute process 1400 with base=b, base_{c}=b, Max phase levels=Mₘₑₐₛ, next (i)=i+1” 1480, in order to generate the first increment phase level hop value for the slit S1, and to set the incremented phase levels for the slit S2 up until the first hop phase level is reached, which can be computed using these settings. Thus, in this example case, the Max phase levels may be set to 8 to 10 phase levels as the first hop, and the process/1460/1400 may compute the phase shifts for the measuring slit pattern of each increment of S2 until it reaches the hop phase level (now Max phase level). The vibration-compensated phase shifts ΔΦ(i) are computed from operations 1426 to 1452 on process 1400 for each of those increments.

Process 1460 may include “for all i=0 . . . . Mₘₑₐₛ−1: Φ_{curv}(b+i)=ΔΦ(i)” 1482, The term Φ_{curv}( ) refers to the phase response curve, and the term Φ_{curv}(b+i) refers to updating of the phase response curve with each phase shift increment determined and up to the increment that has the slit S2 phase level at the first hop phase level.

Process 1460 may include “b=b+Mₘₑₐₛ−1” 1484 and “b_{c}=(b+level_of (π)) mod Mₗₑᵥₑₗₛ” 1486, where the next hop phase level is generated for computation of the phase shifts for the next hop, and the next base settings are set to compute the next group of phase shifts.

Process 1460 may include the inquiry “b<Mₗₑᵥₑₗₛ?” 1488. If not, the incrementation process has ended for the current location, and the full phase response curve is output (or stored) for the current location. If the last measuring slit pair position on the phase map was analyzed, the process is ended.

If the inquiry 1488 is true, the process 1460 then may include “compute next group of phase shifts ΔΦ(i)” 1490. This operation 1490 may include “execute process 1400 with base=b, base_{c}=b_{c}, Max phase levels=Mₘₑₐₛ+1, next (i)=i+1” 1492. This involves the repeat of process 1400 to generate the next group of vibration-compensated phase shifts for increments up to the next hop phase level, similar to operations 1478 and 1480 for the first hop. Here, however, the base_{c} is now set to the b_{c}, and the Max phase level is incremented up by 1.

Process 1460 may include “for all i=0 . . . . Mₘₑₐₛ: Φ_{curv}(b+i)=ΔΦ(i)+Φ_{curv}(b)” 1494, where the phase response curve at the current phase map location is updated with the next hop phase shift measurements. Thereafter, the process 1460 loops back to operation 1484 to set the settings for the group of phase shifts for the next hop.

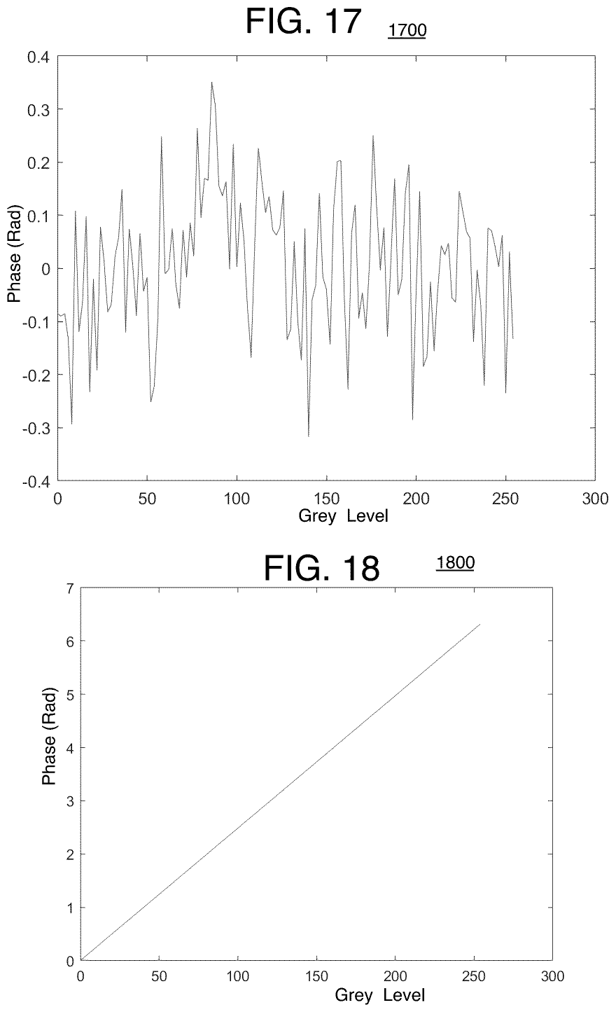

Referring to FIGS. 15-18, graph 1500 shows ground truth as described above, graph 1600 shows measurements with vibration error as mentioned above, graph 1700 shows simulated vibration error measurements of severe vibration (up to +/−20 pixels on a camera image), and graph 1800 shows the corrected phase response compensating for vibration resulting from the methods described herein. The corrected phase response in graph 1800 is very close to the ground truth in graph 1500.

### Diffraction Angle-Dependent Phase Responses

As mentioned above, it was determined that the grating period of a slit pair can be changed to characterize diffraction angle-dependent phase modulation. This can be accomplished by collecting measurements from interference patterns at both +1 and −1 orders on a diffraction pattern image for the same single slit pair while just varying the grating periods. By one example, the grating periods are varied among 2, 4, and 6 with repeating periods in phase level sequences that are described above. This enables the collection of phase modulation responses in six different diffraction angles vertically when the gratings extend vertically. By rotating the slit pair by 90 degrees, the system can collect data for six different diffraction angles extending horizontally. The phase response for each position and orientation of the slit pair on the phase maps, and in turn on the SLM, provides angle-dependent phase responses that can be used to increase the accuracy of far field holography because liquid crystal-based SLMs modulate phase differently in different directions.

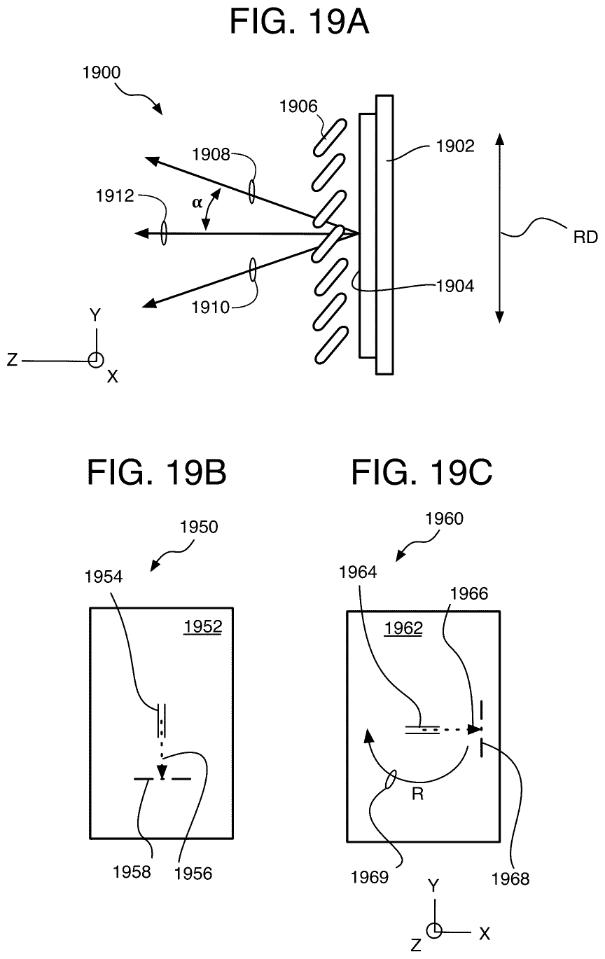

Referring to FIG. 19A, a holographic device 900 has an SLM 1902 with a display or pixel surface 1904 with liquid crystals (LCs) 1906. In more detail, most of the liquid crystal (LC) based phase SLMs are electrically controlled birefringence (ECB) mode displays that use parallel alignment, which refers to the molecular structure where molecules 1906 are parallel to the display or pixel surface 1904, and parallel to the rubbing direction (RD), in a relaxed state. The RD is typically in a Y or X direction relative to the pixel surface 1902 as shown. When voltage is applied, LC molecules 1906 rotate away from the display plane as shown, still staying parallel to each other. The angle of rotation depends on the applied voltage. Linearly polarized light has a different speed in LCs depending on a geometrical angle between LC molecules and a light propagation direction. Thus, by rotating LC molecules to different angles relative to the light propagation direction, the phase of the light can be changed, thereby slowing the light by different amounts. Even the light arriving from the same direction is diffracted differently by the features of a hologram displayed on the SLM, thus interacting with parallel LC molecules at different angles. As a result, phase modulation amount of light leaving the SLM at different directions with respect to a normal to the SLM surface will always be different.

However, during traditional SLM calibration phase modulation is typically measured for light leaving SLM in normal direction for on-axis systems and at a reflection direction for the off-axis systems. For example, if a phase of π is desired, a conventional SLM in an on-axis system only will produce the phase along the direction perpendicular (normal) to the SLM surface direction (or 0 diffraction angle from the propagation direction). Thus, of all the light leaving the face of the pixel surface 1904 on a conventional SLM, only light at ray 1912 will have correct modulation. However, at the light diffracted (and reflected in LCoS case) towards the other rays 1910 and 1908, ray 1910 will experience under modulation with a phase of 0.8π or over modulation at ray 1908 (at diffraction angle α between the ray and the pixel surface normal direction ray 1912) resulting in a phase 1.2 π. Although the effect is very similar in nature to a viewing angle problem of LC displays, it is not accounted for in holography. Additionally, this effect might vary depending on the SLM pixel on the surface 1904.

If known, these direction dependent variations in phase can be compensated for. One can measure the integral effect of light interacting with LC molecules at different directions by measuring overall phase modulation for light leaving in a number of specific directions. The measurement directions span the entire range of possible projection directions, and measurement results can be interpolated for intermediate angles. Particularly, with the slit pair phase shift measurement described herein, this permits the phase shift to be measured for specific grating periods. Each grating period corresponds to a particular offset of the measuring interference pattern on the screen, or angle of light leaving the SLM at a particular direction. Thus, by using gratings of different periods, phase response can be measured for the light leaving the SLM at different angles. From the grating period, the pixel pitch, and the wavelength of a list pair, the system can use a diffraction grating formula to easily determine the diffraction angle, which is the measurement angle for a given grating period. The same diffraction grating formula describes angles for the interference pattern orders of the slit pairs. Thus, by including −1^{st} and other orders into measurements, this enables the system to cover a full range of possible projection angles. This in turn enables the storing of different actual phase response transfer curves depending on diffraction angle. The phase responses can be used to interpolate the proper voltage needed for a desired diffraction angle at particular pixels.

Referring to FIGS. 19B-19C, the diffraction angle varies from an SLM pixel in both a Z direction as shown with angle α in FIG. 19A, and a radial rotational direction in the X-Y plane of the SLM surface for example. Thus, the orientation of the grating pattern used to generate the phase shifts should be rotated to take phase measurements for different rotational angles. For example, a holographic arrangement 1950 has an interference pattern image 1952 with a vertical double slit grating pattern 1954 superimposed thereon and with grating slits extending vertically. The resulting rotational diffraction angle 1956 from the vertical grating pattern 1954 will extend vertically downward (and upward, but upward is not shown for simplicity). The diffraction angle 1956 will extend to a resulting interference pattern order 1958 that will extend horizontally. Likewise, a holographic arrangement 1960 has an interference pattern image 1962 with a horizontal double slit grating pattern 1964 superimposed thereon and rotated an amount R, here R=90 degrees so that the grating slits extend horizontally. The resulting rotational diffraction angle 1966 from the horizontal grating pattern 1964 will extend horizontally to the right (and left) to a resulting interference pattern order 1968 that will extend vertically. Changing grating periods in the slit pairs will result in vertical shift of the pattern 1958 or horizontal shift of the pattern 1968, thus providing additional measuring direction and a sample of response curve. For parallel alignment ECB SLMs, only the rubbing direction orientation will have great variation in response curve. Rubbing direction is vertical or horizontal. If the rubbing direction is vertical, then the response curve might be considered the same along horizontal lines of the holographic projection image. In this case, it is sufficient to recover modulation curves for the multitude of vertical shifts with respect to the center of the image, which can be done by varying periods in the gratings of slit pair 1954 and subsequent interpolation. If the rubbing direction is horizontal, then the response curve might be considered the same along vertical lines of the holographic projection image. In this latter case then, it is sufficient to recover modulation curves for the multitude of horizontal shifts with respect to the center of the image, which can be done by varying periods in the gratings of slit pair 1964 and subsequent interpolation.

Referring to FIG. 20, in an experiment to analyze the data collected for angle-dependent phase responses, double gratings of different grating periods were used on actual LCOS SLM in an ECB mode and with a vertical rubbing direction. The results are shown on graph 2000 where the curves with long dashes corresponds to phase measured with a slit pair of grating period 2 pixels (+1 order interference pattern is for the higher curve and −1 order interference pattern is for the lower curve), and these curves have the largest diffraction angle of +/−4.3 degrees. The solid curves were formed from a slit pair of grating period 4 pixels (+1 and −1 order interference patterns) had a smaller diffraction angle of +/−2.15 degrees, which is closer to the normal target direction. The curves shown as dots used a slit pair of grating period 4 pixels (+1 and −1 order interference patterns) and resulted in an even smaller diffraction angle of +/−1.43 degrees, which was the closest to the normal direction. Notably, collecting the same data in an X direction (orthogonal to the rubbing direction) results in very little directional variation in response curves, confirming and illustrating ECB LC working principles.

As shown, the difference in phase modulation curves can reach 30% depending on direction. Also, the SLM did not need to be modified to generate the angle-dependent phase responses, this process is a self-reference method that enabled measurement of the angle-dependent phase modulation responses

To estimate the effect of angular variation of phase modulation one can easily design a computational optical field propagation model taking such variation into account by modifying source optical field inside Fresnel or Fraunhofer far field integral and making it dependent on the target pixel coordinates. This can be done by estimating light direction from source and target coordinates, picking the correspondent response curve, and converting source pixel phase level to phase using the picked curve. Then, the phase can be plugged into the complex exponent which is further multiplied by the source beam intensity. Since the real SLM has only one direction of large angle-dependent variation and in another direction the modulation doesn't change, this can be used to simplify computations of the modified propagation integral by implementing a model that is variable only in one direction (e.g., Y direction only). This can be accomplished by using a series of horizontal 1DFFTs followed by vertical summation. Thus, the complexity of the problem would be W log (W)H², instead of W²H², for the target image of size of W×H pixels. Applying such simulation model to a hologram computed assuming uniform directional response shows degradation of the far field image contrast ratio by 20% and mean square error (MSE) by 5-7%. Furthermore, such propagation model, together with gradient descent optimization, can be used to compute high quality holograms compensating for angular-dependent phase modulation. One example is using auto-differentiation and stochastic gradient descent implementation from known programs.

Referring to FIG. 21, a process 2100 of spatial light modulation calibration with angle-dependent phase response is arranged in accordance with at least some implementations of the present disclosure. In the illustrated implementation, process 2100 may include one or more operations, functions or actions as illustrated by one or more of operations 2102 to 2110 generally numbered evenly. By way of non-limiting example, process 2100 may be described herein with reference to example devices, systems, or arrangements 100, 200, 300, 400, 600, 1200, 1900, 2300, or 2400 of FIGS. 1-4, 6, 12, 19, 23, and 24 respectively, and as discussed herein.

Process 2100 may include “provide a plurality of phase maps to a spatial light modulator (SLM) with pixels and comprising phase levels that indicate a voltage amount or voltage timing or both to be applied to one or more of the pixels” 2102. This may refer to receiving a sequence of the phase maps or a bunch of the phase maps at an SLM to modulate and project the phase maps one at a time.

Operation 2102 may include “wherein individual phase maps comprise at least one slit pair having two gratings each with a phase level sequence and a same grating period” 2104. Thus, each phase map may have a slit pair with two gratings each with a phase level sequence to provide high and low voltage values, and in turn at least two different phase levels on each sequence. The phase levels, and in turn voltage values, may be determined by experimentation to find the values that provide the best angle-dependent phase response results. Thus, by one form, the full range of all available phase levels may be used, or only certain ones of them, and the phase response for the remaining values may be interpolated as needed. The phase levels may be incremented on each or individual available or desired grating pattern locations on the phase maps.

Operation 2102 may include “wherein the grating periods are different from phase map to phase map on at least two of the phase maps” 2106. By one form, at least two grating periods are used, but by another form at least three phase maps are used for a different one of grating periods 2, 4, and 6. The grating periods may be varied for each orientation of the slit pair on the phase maps. Multiple locations on a phase map may be tested as well including with variations of both orientation and grating periods at each or individual locations so that all pixels of the SLM have measured phase responses.

Process 2100 may include “receive image data of captured images of projections of the phase maps from the SLM” 2108, where the captured interference patterns of the projection of the phase maps from the SLM may be obtained. This may include placing the image data of the interference patterns in a memory and then retrieving them from the memory.

Process 2100 may include “determine at least one diffraction angle-dependent phase response transfer curve associated with a different one of the grating periods” 2110. This refers to the analysis of the interference patterns as described above with the vibration compensation phase response generation. Thus, this may include using FFT to compute phase shifts for the interference patterns at the first orders, and storing those phase shifts with the voltage levels or phase levels used as well as the computed diffraction angle for the interference pattern being analyzed to form the phase responses. Thereafter, one phase response transfer curve may be stored for each diffraction angle of the different interference pattern orders, and one for the positive order and one for the negative order of each diffraction angle. The angle-dependent phase responses then may be used to project phase maps to display images during a run time and with greater accuracy. One example application uses gradient descent with the angle-dependent phase responses as described above to generate the high-quality hologram factoring angle-dependent phase response.

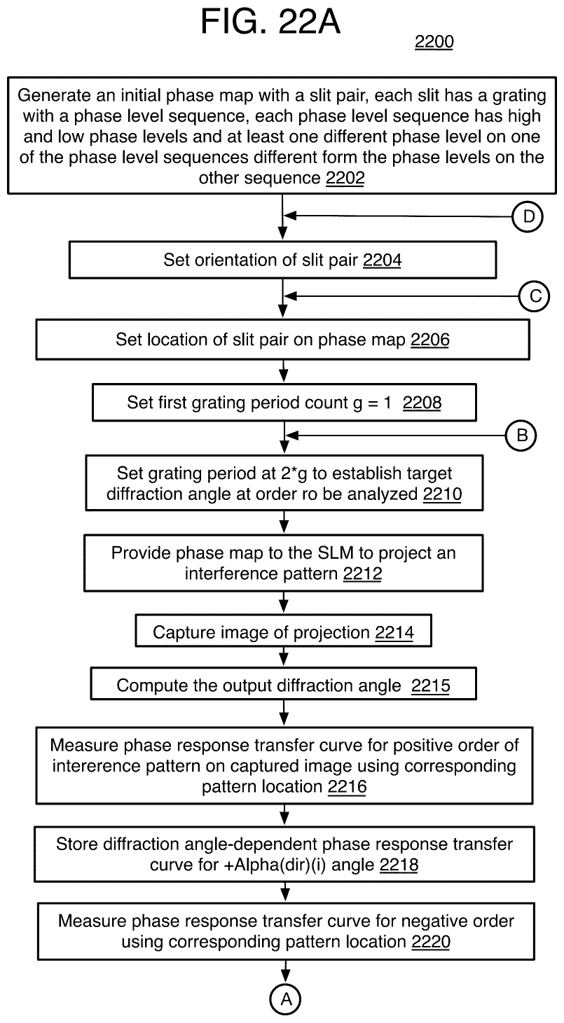

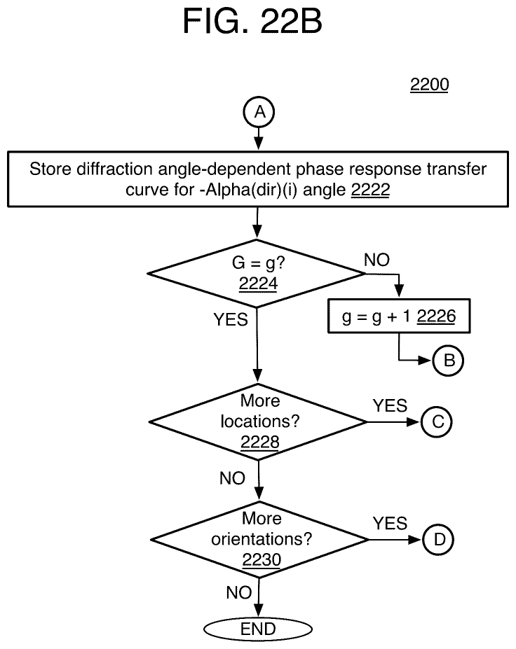

Referring to FIGS. 22A-22B, a detailed process of spatial light modulation calibration with angle-dependent phase response comprises is arranged in accordance with at least some implementations of the present disclosure. In the illustrated implementation, process 2200 may include one or more operations, functions or actions as illustrated by one or more of operations 2202 to 2230 generally numbered evenly. By way of non-limiting example, process 2200 may be described herein with reference to example devices, systems, or arrangements 100, 200, 300, 400, 600, 1200, 1900, 2300, or 2400 of FIGS. 1-4, 6, 12, 19, 23, and 24 respectively, and as discussed herein.

As a preliminary matter, it will be understood that the diffraction angle-dependent phase response transfer curves may be generated by the following process alone or may include subtraction of a base measuring phase shift at each location of a grating pattern on a phase map as described above with base measuring slit pairs. Alternatively, or additionally, the diffraction angle-dependent phase response transfer curves may be generated while using reference or vibration grating patterns to further compensate for vibration as described above as well.

Process 2200 may include “generate an initial phase map with a slit pair, each slit has a grating with a phase level sequence, each phase level sequence has high and low phase levels and at least one different phase level on one of the phase level sequences different from the phase levels on the other sequence” 2202. As mentioned, the best phase levels to use may be determined by experimentation. The phase levels should be incremented at some minimum level, such as every 1 for a range of 0 to 255 to provide accurate phase shifts for all available phase levels (or voltage levels) on the phase responses. The incrementation should be performed for each location, orientation, and grating period.

Process 2200 may include “set orientation of slit pair” 2204, and to set the orientation of the slit pair on a phase map, which may be horizontal, or vertical. It should be noted that the orientation of the gratings of the grating patterns may be set depending on the rubbing direction of the SLM. Specifically, light output from an SLM should be linearly polarized in the rubbing direction. If the SLM's rubbing direction is vertical, light then should be linearly polarized in a vertical direction as well. Thus, to capture the most modulation variation, the slits or gratings of the grating patterns should at least be oriented in the SLM's rubbing direction. Moreover for far field holograms, it is assumed that modulation will be horizontally (or vertically) the same.

Process 2200 may include “set location of slit pair” 2206, and this sets the location of the slit pair on the phase map. The best order and increments of the locations on the phase maps may be determined by experimentation. In this example case, the orientation will remain the same over multiple phase map locations until all desired locations are complete.

Process 2200 may include “set first grating period count g=1” 2208. This is a counter to set the grating period, here among 2, 4, and 6. In this example, the grating periods will be varied for each location at the set orientation.

Thus, process 2200 next may include “set grating period at 2*g to establish target diffraction angle at order to be analyzed” 2210. Thus starting with grating period 2.

Process 2200 may include “provide phase map to the SLM to project an interference pattern” 2212, where the phase map with the slit pair or grating pattern having the set orientation, location, and grating period is provided to the SLM for modulation and projection of a resulting interference pattern to a screen.

Process 2200 may include “capture image of projection” 2214. The camera may or may not be automatically triggered to capture the angle-dependent captured (or trial or calibration) image.

Process 2200 may include “compute the output diffraction angle” 2215. The angle may be computed by:

$${θ}_{m} = arcsin ( sin {θ}_{i} - \frac{m λ}{d} ) \qquad ( 5 )$$

where Θᵢ is the incident or input light angle, λ is input or incident light wavelength, d is distance between the gratings (or slits), and m is the signed interference pattern or diffraction order of interest, here being +1 or −1. The computed angle is then to be associated with a phase response curve.

The operations above are repeated with the same grating pattern orientation, location, and grating period for incremented phase levels enough to fill a phase response transfer curve, so for example either by actual measurement alone with many increments or by interpolation with fewer actual increments. One exemplar process of collecting the full response curve is shown on FIG. 14C.

Process 2200 may include “measure phase response transfer curve for positive order of interference pattern on captured image using corresponding pattern location” 2216. Here, the phase shift for the positive order, such as the +1 order, for a current phase map is computed as described above using FFT.

Process 2200 may include “store diffraction angle-dependent phase response transfer curve for +α(dir)(i) angle” 2218, where α(dir)(i) is the diffraction angle corresponding to the current grating orientation and period, and dir is the direction X or Y, i is the zero-based grating number i=g−1. The entire phase response curve may be measured by the process such as example implementation process 1460 (FIG. 14C) and stored together with the correspondent direction angle alpha indexed by dir and I variables.

Process 2200 may include “measure phase response transfer curve for negative order using corresponding pattern location” 2220, and “store diffraction angle-dependent phase response transfer curve for −α(dir)(i) angle” 2222, which is the same as for the positive order except for a designation as the negative order.

Next, process 2200 may include the inquiry “G=g?” 2224 to determine if all available grating periods have been used already. If not, process 2200 may include “g=g+1” 2226 to increase grating period count, and the process loops back to operation 2210 to begin the phase shift measurement with the next grating period, which would be 4 in the current example. If the grating periods have all been used, process 2200 may include the inquiry “more locations?” 2228. If phase shifts from more locations are still needed, then process 2200 loops back to operation 2206 to set the next phase map location to continue obtaining phase shifts. If all grating periods at all locations with a current orientation have been completed, then process 2200 may include the inquiry “more orientations?” 2230. If phase shifts are to be obtained with another grating pattern orientation, the process loops back to operation 2204 to set the next orientation. If not, the calibration process has ended.

During a run-time, the diffraction angle-dependent phase response curves may be used to display images. The result is at least 2G angle-dependent response curves for vertical angles and 2G angle-dependent phase response curves for horizontal angles. The data can be used to evaluate quality of the SLM in manufacturing processes or may be used to display images during a run time. In order to use the angle-dependent phase response curves, one can modify the far field propagation computational model as described above, and such model is typically a variation of a Fresnel or Fraunhofer integral with source pixel coordinate destination pixel coordinates, and the distance between source and target optical field planes. The values can be used to calculate diffraction angle for a particular pair of source and target points. This angle value and values+−α(dir)(i) can be used to calculate interpolation weights to calculate an interpolated phase for the calculated diffraction angle. That interpolated phase can be used as an SLM phase delay value for the pair of source destination points in question. As outlined above, this model may be used to compute holograms compensating for the angular dependency.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the discussed operations, modules, or components discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality. Component herein also may refer to processors and other specific hardware devices.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

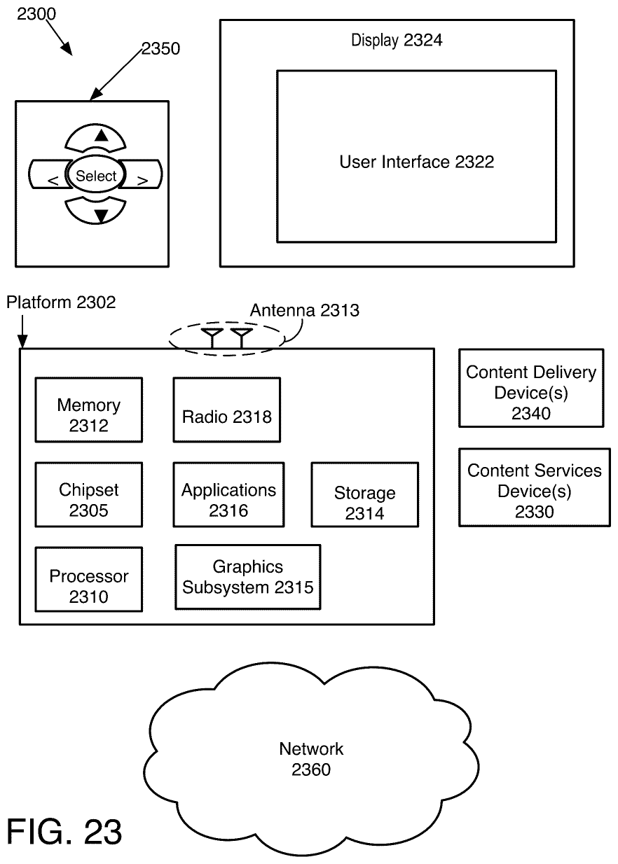

Referring to FIG. 23 is an illustrative diagram of an example system 2300, arranged in accordance with at least some implementations of the present disclosure. In various implementations, system 2300 may be a computing system although system 2300 is not limited to this context. For example, system 2300 may be incorporated into a personal computer (PC), laptop computer, ultra-laptop computer, tablet, phablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, peripheral device, gaming console, wearable device, display device, all-in-one device, two-in-one device, and so forth.

In various implementations, system 2300 includes a platform 2302 coupled to a display 2320. Platform 2302 may receive content from a content device such as content services device(s) 2330 or content delivery device(s) 2340 or other similar content sources such as a camera or camera module or the like. A navigation controller 2350 including one or more navigation features may be used to interact with, for example, platform 2302 and/or display 2320. Each of these components is described in greater detail below.

In various implementations, platform 2302 may include any combination of a chipset 2305, processor 2310, memory 2312, antenna 2313, storage 2314, graphics subsystem 2315, applications 2316, and/or radio 2318. Chipset 2305 may provide intercommunication among processor 2310, memory 2312, storage 2314, graphics subsystem 2315, applications 2316 and/or radio 2318. For example, chipset 2305 may include a storage adapter (not depicted) capable of providing intercommunication with storage 2314.

Processor 2310 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 2310 may be dual-core processor(s), dual-core mobile processor(s), and so forth.

Memory 2312 may be implemented as a volatile memory device such as, but not limited to, a Random Access Memory (RAM), Dynamic Random Access Memory (DRAM), or Static RAM (SRAM).

Storage 2314 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 2314 may include technology to increase the storage performance enhanced protection for valuable digital media when multiple hard drives are included, for example.

Graphics subsystem 2315 may perform processing of images such as still images, graphics, or video for display. Graphics subsystem 2315 may be a graphics processing unit (GPU), a visual processing unit (VPU), or an image processing unit, for example. In some examples, graphics subsystem 2315 may perform holographic or SLM image processing as discussed herein. An analog or digital interface may be used to communicatively couple graphics subsystem 2315 and display 2320. For example, the interface may be any of a High-Definition Multimedia Interface, DisplayPort, wireless HDMI, and/or wireless HD compliant techniques. Graphics subsystem 2315 may be integrated into processor 2310 or chipset 2305. In some implementations, graphics subsystem 2315 may be a stand-alone device communicatively coupled to chipset 2305.

The image processing techniques described herein may be implemented in various hardware architectures. For example, image processing functionality may be integrated within a chipset. Alternatively, a discrete graphics and/or image processor and/or application specific integrated circuit may be used. As still another implementation, the image processing may be provided by a general purpose processor, including a multi-core processor. In further implementations, the functions may be implemented in a consumer electronics device.

Radio 2318 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 2318 may operate in accordance with one or more applicable standards in any version.

In various implementations, display 2320 may include any flat panel monitor or display. Display 2320 may include, for example, a computer display screen, touch screen display, video monitor, television-like device, and/or a television. Display 2320 may be digital and/or analog. In various implementations, display 2320 may be a holographic or SLM modulated and/or projected display. Also, display 2320 may be a transparent surface that may receive a visual projection. Such projections may convey various forms of information, images, and/or objects. For example, such projections may be a visual overlay for a mobile augmented reality (MAR) application. Under the control of one or more software applications 2316, platform 2302 may display user interface 2322 on display 2320.

In various implementations, content services device(s) 2330 may be hosted by any national, international and/or independent service and thus accessible to platform 2302 via the Internet, for example. Content services device(s) 2330 may be coupled to platform 2302 and/or to display 2320. Platform 2302 and/or content services device(s) 2330 may be coupled to a network 2360 to communicate (e.g., send and/or receive) media information to and from network 2360. Content delivery device(s) 2340 also may be coupled to platform 2302 and/or to display 2320.

In various implementations, content services device(s) 2330 may include a cable television box, personal computer, network, telephone, Internet enabled devices or appliance capable of delivering digital information and/or content, and any other similar device capable of uni-directionally or bi-directionally communicating content between content providers and platform 2302 and/display 2320, via network 2360 or directly. It will be appreciated that the content may be communicated uni-directionally and/or bi-directionally to and from any one of the components in system 2300 and a content provider via network 2360. Examples of content may include any media information including, for example, video, music, medical and gaming information, and so forth.

Content services device(s) 2330 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 2302 may receive control signals from navigation controller 2350 having one or more navigation features. The navigation features of navigation controller 2350 may be used to interact with user interface 2322, for example. In various implementations, navigation controller 2350 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 2350 may be replicated on a display (e.g., display 2320) by movements of a pointer, cursor, focus ring, or other visual indicators displayed on the display. For example, under the control of software applications 2316, the navigation features located on navigation controller 2350 may be mapped to virtual navigation features displayed on user interface 2322, for example. In various implementations, navigation controller 2350 may not be a separate component but may be integrated into platform 2302 and/or display 2320. The present disclosure, however, is not limited to the elements or in the context shown or described herein.

In various implementations, drivers (not shown) may include technology to enable users to instantly turn on and off platform 2302 like a television with the touch of a button after initial boot-up, when enabled, for example. Program logic may allow platform 2302 to stream content to media adaptors or other content services device(s) 2330 or content delivery device(s) 2340 even when the platform is turned “off.” In addition, chipset 2305 may include hardware and/or software support for 5.1 surround sound audio and/or high definition 7.1 surround sound audio, for example. Drivers may include a graphics driver for integrated graphics platforms. In various implementations, the graphics driver may include a peripheral component interconnect (PCI) Express graphics card.

In various implementations, any one or more of the components shown in system 2300 may be integrated. For example, platform 2302 and content services device(s) 2330 may be integrated, or platform 2302 and content delivery device(s) 2340 may be integrated, or platform 2302, content services device(s) 2330, and content delivery device(s) 2340 may be integrated, for example. In various implementations, platform 2302 and display 2320 may be an integrated unit. Display 2320 and content service device(s) 2330 may be integrated, or display 2320 and content delivery device(s) 2340 may be integrated, for example. These examples are not meant to limit the present disclosure.

In various implementations, system 2300 may be implemented as a wireless system, a wired system, or a combination of both. When implemented as a wireless system, system 2300 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 2300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 2302 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 23.

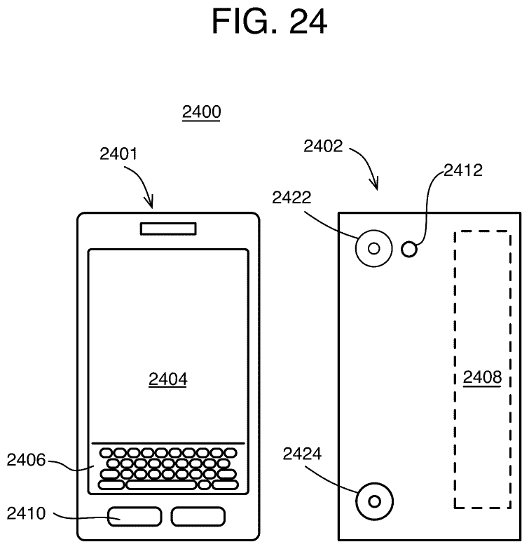

As described above, system 100, 200, 300, 1200, or 1900 may be embodied in varying physical styles or form factors. FIG. 24 illustrates an example small form factor device 2400, arranged in accordance with at least some implementations of the present disclosure. In some examples, system 100, 200, 300, 1200, or 1900 may be implemented via device 2400. In various implementations, for example, device 2400 may be implemented as a holographic projector or remote control or remote image processing device for a holographic projector or other mobile computing device having wireless capabilities as described above. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as a wrist computer, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 24, device 2400 may include a housing with a front 2401 and a back 2402. Device 2400 includes a display 2404, an input/output (I/O) device 2406, and an integrated antenna 2408. Device 2400 also may include navigation features 2410. I/O device 2406 may include any suitable I/O device for entering information into a mobile computing device. Examples for I/O device 2406 may include an alphanumeric keyboard, a numeric keypad, a touch pad, input keys, buttons, switches, microphones, speakers, voice recognition device and software, and so forth. Information also may be entered into device 2400 by way of microphone (not shown), or may be digitized by a voice recognition device. As shown, device 2400 may include one or more cameras 2422 and 2421 (e.g., including a lens, an aperture, and an imaging sensor) and a flash 2412 integrated into back 2402 (or elsewhere) of device 2400. In other examples, camera 2422 and flash 2412 may be integrated into front 2401 of device 2400 or both front and back cameras may be provided. Camera 2422 and flash 2412 may be components of a camera module to originate image data processed into streaming video that is output to display 2404 and/or communicated remotely from device 2400 via antenna 2408 for example.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further implementations.

In an example 1, a method comprises providing at least one phase map to a spatial light modulator (SLM) with pixels and comprising phase levels that indicate voltage amount or voltage timing or both to be applied to one or more of the pixels, and wherein the phase map has at least one first slit pair having two gratings each with a phase level sequence having a first grating period, wherein at least one phase level of one of the phase level sequences is different than all phase levels on the other phase level sequence, and wherein the phase map has a second slit pair having two gratings with the same phase level sequence and having a second grating period different than the first grating period; receiving image data of a captured image of a projection of the phase map from the SLM; and determining a phase response transfer curve using the image data.

In an example 2, the subject matter of example 1 wherein the method comprises comprising providing a plurality of phase maps, wherein individual phase maps have the first slit pair at a different location than other phase maps of the plurality of the phase maps, and the second slit pair is at the same location on the plurality of the phase maps.

In example 3, the subject matter of example 1 or 2 wherein the gratings of both the first and second slit pairs extend in parallel on the same phase map.

In example 4, the subject matter of any one of examples 1 to 3 wherein the method comprises generating a reference base phase shift of one of the second slit pairs and reference subsequent phase shifts of multiple individual phase shifts of other reference subsequent second slit pairs; and using the reference base phase shift to adjust the reference subsequent phase shifts before using the reference subsequent phase shifts to determine the phase response transfer curve.

In example 5, the subject matter of any one of examples 1 to 4 wherein the method comprises generating a measuring base phase shift of one of the first slit pairs and measuring subsequent phase shifts of multiple individual phase shifts of other subsequent first slit pairs; and using the measuring base phase shift to adjust the measuring subsequent phase shifts before using the measuring subsequent phase shifts to determine the phase response transfer curve.

In example 6, the subject matter of any one of examples 1 to 5 wherein a lower and higher phase level remains the same for 8 to 10 increments on one of the gratings of the first slit pair while a lower or higher or both phase level of another grating of the first slit pair being incremented over multiple phase maps.

In example 7, the subject matter of any one of examples 1 to 6 wherein the determining of a phase response transfer curve comprises using one interference pattern on the captured image to determine a phase shift of the first slit pair and another interference pattern on the captured image to determine the phase shift of the second slit pair.

In example 8, the subject matter of any one of examples 1 to 7 wherein the determining of a phase response transfer curve comprises using a phase shift of the second slit pair to modify a phase shift of the first slit pair.

In example 9, the subject matter of any one of examples 1 to 8 wherein the determining of a phase response transfer curve comprises subtracting a phase shift of the second slit pair from a phase shift of the first slit pair.

In example 10, a holographic projector system comprises memory to store holographic data associated with a spatial light modulator (SLM); and processor circuitry communicatively coupled to the memory and to operate by: providing at least one phase map to a spatial light modulator (SLM) with pixels and comprising phase levels that indicate voltage amount or voltage timing or both to be applied to one or more of the pixels, and wherein the phase map has at least one first slit pair having two gratings each with a phase level sequence having a first grating period, wherein at least one phase level of one of the phase level sequences is different than all phase levels on the other phase level sequence, and wherein the phase map has a second slit pair having two gratings with the same phase level sequence and having a second grating period different than the first grating period; receiving image data of a captured image of a projection of the phase map from the SLM; and determining a phase response transfer curve using the image data.

In example 11, the subject matter of example 10 wherein the first period comprises a repeating pattern of one low phase level adjacent one high phase level, and the second period comprises a repeating pattern of at least two consecutive low phase levels and at least two consecutive high phase levels.

In example 12, the subject matter of examples 10 or 11 wherein the second period comprises a repeating pattern of three consecutive low phase levels and three consecutive high phase levels.

In example 13, the subject matter of any one of examples 10 to 12 wherein the captured image comprises an interference pattern of the second slit pair at a farther location from a center interference pattern on the captured image than an interference pattern of the first slit pair.

In example 14, the subject matter of any one of examples 10 to 13 wherein the gratings of the first and second slit pairs are parallel, and wherein the gratings of the first slit pair do not generally extend in the same row and column of the gratings of the second slit pair.

In example 15, At least one non-transitory machine readable medium comprising a plurality of instructions that, in response to being executed on a computing device, cause the computing device to operate by: providing a plurality of phase maps to a spatial light modulator (SLM) with pixels and comprising phase levels that indicate a voltage amount or voltage timing or both to be applied to one or more of the pixels, wherein individual phase maps comprise at least one slit pair having two gratings each with a phase level sequence and a same grating period, wherein the grating periods are different from phase map to phase map on at least two of the phase maps; receiving image data of captured images of projections of the phase maps from the SLM; determining at least one diffraction angle-dependent phase response transfer curve associated with a different one of the grating periods.

In example 16, the subject matter of example 15 wherein the phase maps have grating periods of two, four, and six pixel rows or columns on different phase maps.

In example 17, the subject matter of examples 15 or 16 wherein the instructions cause the computing device to operate by determining diffraction angle-dependent phase response transfer curves of both a positive and negative interference pattern of the same grating period.

In example 18, the subject matter of any one of examples 15 to 17 wherein the plurality of phase maps comprises phase maps with the slit pair at different rotational orientations on at least two of the phase maps.

In example 19, the subject matter of any one of examples 15 to 18 wherein the plurality of phase maps comprises phase maps with the slit pair at different locations on the phase maps.

In example 20, the subject matter of any one of examples 15 to 19 wherein the at least one slit pair is a phase-measuring slit pair, wherein the phase maps have both the phase-measuring slit pair and a reference slit pair, wherein the reference slit pair has two gratings each with the same phase level sequence phase levels and a grating period different than the grating period of the phase-measuring slit pair.

In example 21, at least one machine readable medium includes a plurality of instructions that in response to being executed on a computing device, cause the computing device to perform a method according to any one of the above implementations.

In example 22, an apparatus may include means for performing a method according to any one of the above implementations.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A method comprising:
providing at least one phase map to a spatial light modulator (SLM) with pixels and comprising phase levels that indicate voltage amount or voltage timing or both to be applied to one or more of the pixels, and
wherein the phase map has at least one first slit pair having two gratings each with a phase level sequence having a first grating period, wherein at least one phase level of one of the phase level sequences is different than all phase levels on the other phase level sequence, and
wherein the phase map has a second slit pair having two gratings with the same phase level sequence and having a second grating period different than the first grating period;
receiving image data of a captured image of a projection of the phase map from the SLM; and
determining a phase response transfer curve using the image data.

2. The method of claim 1, comprising providing a plurality of phase maps, wherein individual phase maps have the first slit pair at a different location than other phase maps of the plurality of the phase maps, and the second slit pair is at the same location on the plurality of the phase maps.

3. The method of claim 2, wherein the gratings of both the first and second slit pairs extend in parallel on the same phase map.

4. The method of claim 1, comprising generating a reference base phase shift of the second slit pairs and reference subsequent phase shifts of multiple individual phase shifts of other subsequent second slit pairs; and using the reference base phase shift to adjust the reference subsequent phase shifts before using the reference subsequent phase shifts to determine the phase response transfer curve.

5. The method of claim 1, comprising generating a measuring base phase shift of the first slit pairs and subsequent phase shifts of multiple individual measuring phase shifts of other subsequent first slit pairs; and using the measuring base phase shift to adjust the measuring subsequent phase shifts before using the measuring subsequent phase shifts to determine the phase response transfer curve.

6. The method of claim 5, wherein a lower and higher phase level remains the same for 8 to 10 increments on one of the gratings of the first slit pair while a lower or higher or both phase level of another grating of the first slit pair being incremented over multiple phase maps.

7. The method of claim 1, wherein the determining of a phase response transfer curve comprises using one interference pattern on the captured image to determine a phase shift of the first slit pair and another interference pattern on the captured image to determine the phase shift of the second slit pair.

8. The method of claim 1, wherein the determining of a phase response transfer curve comprises using a phase shift of the second slit pair to modify a phase shift of the first slit pair.

9. The method of claim 1, wherein the determining of a phase response transfer curve comprises subtracting a phase shift of the second slit pair from a phase shift of the first slit pair.

10. A holographic projector system comprising:
memory to store holographic data associated with a spatial light modulator (SLM); and
processor circuitry communicatively coupled to the memory and to operate by:
providing at least one phase map to a spatial light modulator (SLM) with pixels and comprising phase levels that indicate voltage amount or voltage timing or both to be applied to one or more of the pixels, and
wherein the phase map has at least one first slit pair having two gratings each with a phase level sequence having a first grating period, wherein at least one phase level of one of the phase level sequences is different than all phase levels on the other phase level sequence, and
wherein the phase map has a second slit pair having two gratings with the same phase level sequence and having a second grating period different than the first grating period;
receiving image data of a captured image of a projection of the phase map from the SLM; and
determining a phase response transfer curve using the image data.

11. The system of claim 10, wherein the first period comprises a repeating pattern of one low phase level adjacent one high phase level, and the second period comprises a repeating pattern of at least two consecutive low phase levels and at least two consecutive high phase levels.

12. The system of claim 11, wherein the second period comprises a repeating pattern of three consecutive low phase levels and three consecutive high phase levels.

13. The system of claim 10, wherein the captured image comprises an interference pattern of the second slit pair at a farther location from a center interference pattern on the captured image than an interference pattern of the first slit pair.

14. The system of claim 10, wherein the gratings of the first and second slit pairs are parallel, and wherein the gratings of the first slit pair do not generally extend in the same row and column of the gratings of the second slit pair.

15. At least one non-transitory machine readable medium comprising a plurality of instructions that, in response to being executed on a computing device, cause the computing device to operate by:
providing a plurality of phase maps to a spatial light modulator (SLM) with pixels and comprising phase levels that indicate a voltage amount or voltage timing or both to be applied to one or more of the pixels, wherein individual phase maps have at least one slit pair having two gratings each with a phase level sequence and a same grating period, wherein the grating periods are different from phase map to phase map on at least two of the phase maps;
receiving image data of captured images of projections of the phase maps from the SLM;
determining at least one diffraction angle-dependent phase response transfer curve associated with a different one of the grating periods.

16. The medium of claim 15, wherein the phase maps have grating periods of two, four, and six pixel rows or columns on different phase maps.

17. The medium of claim 15, wherein the instructions cause the computing device to operate by determining diffraction angle-dependent phase response transfer curves of both a positive and negative interference pattern of the same grating period.

18. The medium of claim 15, wherein the plurality of phase maps comprises phase maps with the slit pair at different rotational orientations on at least two of the phase maps.

19. The medium of claim 15, wherein the plurality of phase maps comprises phase maps with the slit pair at different locations on the phase maps.

20. The medium of claim 15 wherein the at least one slit pair is a phase-measuring slit pair, wherein the phase maps have both the phase-measuring slit pair and a reference slit pair, wherein the reference slit pair has two gratings each with the same phase level sequence phase levels and a grating period different than the grating period of the phase-measuring slit pair.
